(19) United States
(12) Patent Application Publication
(10) Pub. No.: US 2025/0313191 A1
(43) Pub. Date: Oct. 9, 2025

(54) SYSTEMS AND METHODS FOR VEHICLE ROLLOVER PREVENTION

(71) Applicants: Daimler Truck North America LLC, Portland, OR (US); Auburn University, Auburn, AL (US)

(72) Inventors: Jake WARD, Auburn, AL (US); Lowell BROWN, Portland, OR (US); Cristin PAUN, Portland, OR (US)

(73) Assignees: Daimler Truck North America LLC, Portland, OR (US); Auburn University, Auburn, AL (US)

(21) Appl. No.: 19/091,980

(22) Filed: Mar. 27, 2025

Related U.S. Application Data
(60) Provisional application No. 63/571,440, filed on Mar. 29, 2024.

(51) Int. Cl. B60W 30/04; B60W 50/00

(52) U.S. Cl. CPC B60W 30/04; B60W 50/0097; B60W 2300/14; B60W 2520/125; B60W 2710/207

(57) ABSTRACT

Embodiments relate to method for a vehicle comprising, retrieving data from one or more sensors positioned on a tractor of the vehicle, wherein the tractor is mechanically coupled using a mechanical coupling to a trailer forming a tractor-trailer system, determining based on the data retrieved from the one or more sensors a lateral acceleration parameter of the tractor, and controlling based on the lateral acceleration parameter of the tractor a steering angle of steered wheels of the tractor such that lateral acceleration of the vehicle is held below a threshold lateral acceleration; and wherein the threshold lateral acceleration is selected such that rollover of one or more of the tractor and the trailer is avoided.

### CROSS-REFERENCE TO RELATED APPLICATIONS

This application claims the benefit under 35 U.S.C § 119 of U.S. Provisional Application No. 63/571,440, filed on Mar. 29, 2024, which is hereby incorporated by reference in its entirety.

### TECHNICAL FIELD

This disclosure relates to systems and methods for preventing a rollover of a dynamic system and more particularly for preventing rollover of a tractor-trailer combination vehicle.

### BACKGROUND

Current market solutions for rollover prevention require an add-on module to the trailer. The add-on module has a built-in inertial measurement unit (IMU) to measure lateral acceleration of the trailer. The system will apply one or more of differential braking and steering to reduce lateral acceleration if a certain threshold is exceeded.

Current solutions on the market require the purchase of a Roll Stability Control (RSC) module for every trailer because of which expenses would be prohibitive for many customers. RSC modules may have a built-in accelerometer to measure trailer acceleration. Such solutions are not practical when picking up and dropping off trailers for other companies/of different sizes and models.

Therefore, there is a need for an approach to reduce rollover risk with no additional add-on modules and/or cost and further an approach that is suitable/adaptable when different trailers are used with a vehicle or tractor.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, disclosed is a method for a vehicle, comprising retrieving data from one or more sensors positioned on a tractor of the vehicle, wherein the tractor is mechanically coupled using a mechanical coupling to a trailer forming a tractor-trailer system; determining, based on the data retrieved from the one or more sensors, a lateral acceleration parameter of the tractor; and controlling based on the lateral acceleration parameter of the tractor, a steering angle of steered wheels of the tractor such that lateral acceleration of the vehicle is held below a threshold lateral acceleration, and wherein one or more sensors comprise at least Inertial measurement unit (IMU), inductive sensors for measuring road wheel speed, and Global Positioning System (GPS); and wherein the vehicle is the tractor-trailer system.

According to an embodiment of the method, which optionally includes any one or more of previous embodiments, the threshold lateral acceleration is selected such that rollover of one or more of the tractor and the trailer is avoided.

According to an embodiment of the method, which optionally includes any one or more of previous embodiments, the one or more sensors comprises an accelerometer.

According to an embodiment of the method, which optionally includes any one or more of previous embodiments, the accelerometer is part of an inertial measurement unit of the vehicle.

According to an embodiment of the method, which optionally includes any one or more of previous embodiments, the mechanical coupling.

According to an embodiment of the method, which optionally includes any one or more of previous embodiments, the lateral acceleration parameter of the vehicle is held below the threshold lateral acceleration by a reference governor.

According to an embodiment of the method, which optionally includes any one or more of previous embodiments, the reference governor receives a reference of the lateral acceleration parameter for a maneuver path from an Advanced Driver Assistance System (ADAS).

According to an embodiment of the method, which optionally includes any one or more of previous embodiments, the maneuver path is an obstacle avoidance path generated after sensing an obstacle in the current path/current trajectory which the vehicle is following.

According to an embodiment of the method, which optionally includes any one or more of previous embodiments, the reference governor is configured as a chance constrained reference governor such that the lateral acceleration parameter of the vehicle is held below the threshold lateral acceleration with a predefined probability.

According to an embodiment of the method, which optionally includes any one or more of previous embodiments, the steering angle is controlled via an actuator configured to control an angle of steered wheels.

According to an embodiment of the method, which optionally includes any one or more of previous embodiments, the method is configured to change a current state of the tractor-trailer system to a next state.

According to an embodiment of the method, which optionally includes any one or more of previous embodiments, the tractor-trailer system is controlled using a data-driven model.

According to an embodiment of the method, the data-driven model comprises an ultra-local model.

According to an embodiment of the method, which optionally includes any one or more of previous embodiments, the ultra-local model is formulated such that a future state depends on a current state and a reference, wherein the current state is the lateral acceleration parameter of the tractor in a current time period and the reference is a lateral acceleration predicted along a maneuver path at an immediate future time period.

According to an embodiment of the method, which optionally includes any one or more of previous embodiments, the reference is modified by reference governor for enforcement of a constraint on an allowable maximum lateral acceleration of the tractor-trailer system.

According to an embodiment of the method, which optionally includes any one or more of previous embodiments, the maneuver path is generated from an ADAS of the vehicle.

According to an embodiment of the method, which optionally includes any one or more of previous embodiments, the allowable maximum lateral acceleration of the tractor-trailer system is generated based on an amplification factor of the lateral acceleration from the tractor to the trailer.

According to an embodiment, disclosed is a control system comprising a sensor, a reference governor, and a feedback controller; the sensor configured to provide real-time data comprising a current state of a dynamic system, wherein the dynamic system is a tractor-trailer combination vehicle, and the current state comprises a current lateral acceleration of a tractor of the tractor-trailer combination vehicle; the reference governor, configured to output a modified reference based on an input reference and the current state such that the dynamic system satisfies a constraint; the feedback controller configured to determine a value of a control input based on the modified reference and the current state; and wherein the control system is configured for a data-driven model based control comprising an ultra-local model of the dynamic system; and wherein the control system is configured for preventing a rollover of the tractor-trailer combination vehicle.

According to an embodiment of the control system, which optionally includes any one or more of previous embodiments, the sensor comprises an accelerometer.

According to an embodiment of the control system, which optionally includes any one or more of previous embodiments, the accelerometer is part of an inertial measurement unit of a vehicle.

According to an embodiment of the control system, which optionally includes any one or more of previous embodiments, the tractor and trailer are connected via a mechanical coupling.

According to an embodiment of the control system, which optionally includes any one or more of previous embodiments, the modified reference satisfies the constraint on allowable maximum lateral acceleration of the tractor-trailer combination vehicle.

According to an embodiment of the control system, which optionally includes any one or more of previous embodiments, the reference governor receives the input reference for a maneuver path from an Advanced Driver Assistance System (ADAS).

According to an embodiment of the control system, which optionally includes any one or more of previous embodiments, the maneuver path is an obstacle avoidance path generated after sensing an obstacle along a current trajectory of the tractor-trailer combination vehicle.

According to an embodiment of the control system, which optionally includes any one or more of previous embodiments, the maneuver path is generated from an ADAS of the vehicle.

According to an embodiment of the control system, which optionally includes any one or more of previous embodiments, the reference governor is configured as a chance constrained reference governor such that the modified reference satisfies the constraint with a predefined probability.

According to an embodiment of the control system, which optionally includes any one or more of previous embodiments, the constraint is a maximum allowable lateral acceleration for the tractor-trailer combination vehicle to prevent the rollover of one or more of the tractor and the trailer.

According to an embodiment of the control system, which optionally includes any one or more of previous embodiments, the input reference is a predicted lateral acceleration at a future time period.

According to an embodiment of the control system, which optionally includes any one or more of previous embodiments, the current state is the current lateral acceleration.

According to an embodiment of the control system, which optionally includes any one or more of previous embodiments, the control input is a steering angle for wheels of the tractor.

According to an embodiment of the control system, which optionally includes any one or more of previous embodiments, an actuator is configured to receive and implement the control input changing the current state of the dynamic system to a next state.

According to an embodiment of the control system, which optionally includes any one or more of previous embodiments, the reference governor is configured to handle a disturbance that is unbounded and stochastic.

According to an embodiment of the control system, which optionally includes any one or more of previous embodiments, the disturbance is represented as a Gaussian distribution.

According to an embodiment of the control system, which optionally includes any one or more of previous embodiments, the steering angle is received by an actuator.

According to an embodiment of the control system, which optionally includes any one or more of previous embodiments, the control system is configured to change the current state of the tractor-trailer combination vehicle to a next state.

According to an embodiment of the control system, which optionally includes any one or more of previous embodiments, the feedback controller uses a data-driven model.

According to an embodiment of the control system, which optionally includes any one or more of previous embodiments, the data-driven model comprises the ultra-local model.

According to an embodiment of the control system, which optionally includes any one or more of previous embodiments, the ultra-local model is formulated such that a future state depends on the current state and a reference, wherein the current state is the lateral acceleration of the tractor in a current time period and the reference is a lateral acceleration predicted along a maneuver path at an immediate future time period.

According to an embodiment, disclosed is a method comprising receiving, from a sensor, a real-time data comprising a current state of a dynamic system, wherein the dynamic system is a tractor-trailer combination vehicle, and the current state comprises a current lateral acceleration of a tractor of the tractor-trailer combination vehicle; generating, by a reference governor, an output comprising a modified reference based on an input reference and the current state such that the dynamic system satisfies a constraint; determining, by a feedback controller, a value of a control input based on the modified reference and the current state; and wherein the method is implemented by a control system that is configured for preventing a rollover of the dynamic system.

According to an embodiment of the method, which optionally includes any one or more of previous embodiments, the constraint is a maximum allowable lateral acceleration for the tractor-trailer combination vehicle to prevent the rollover.

According to an embodiment of the method, which optionally includes any one or more of previous embodiments, the maximum allowable lateral acceleration of the tractor-trailer combination vehicle is generated using an amplification factor of a lateral acceleration from the tractor to the trailer.

According to an embodiment of the method, which optionally includes any one or more of previous embodiments, the constraint is enforced with a predefined probability.

According to an embodiment of the method, which optionally includes any one or more of previous embodiments, the predefined probability is in a range of 0.8 to 0.9999.

According to an embodiment of the method, which optionally includes any one or more of previous embodiments, the input reference is a predicted lateral acceleration at a future time period.

According to an embodiment of the method, which optionally includes any one or more of previous embodiments, the control input is a steering angle for wheels of the tractor.

According to an embodiment of the method, which optionally includes any one or more of previous embodiments, the control input is sent to an actuator.

According to an embodiment of the method, which optionally includes any one or more of previous embodiments, the control input upon implementation by the actuator changes the current state of the dynamic system to a next state.

According to an embodiment of the method, which optionally includes any one or more of previous embodiments, the control system is configured as a data-driven model based control comprising an ultra-local model of the dynamic system.

According to an embodiment of the method, which optionally includes any one or more of previous embodiments, the ultra-local model operates in background, estimating dynamics of the dynamic system while the tractor-trailer combination vehicle is in nominal operation in real-time.

According to an embodiment of the method, which optionally includes any one or more of previous embodiments, the method is configured to be used in a maneuver path with a risk of rollover.

According to an embodiment, disclosed is a non-transitory computer-readable storage medium having stored thereon instructions executable by a computer system to perform operations comprising receiving, from a sensor, a real-time data comprising a current state of a dynamic system, wherein the dynamic system is a tractor-trailer combination vehicle, and the current state comprises a current lateral acceleration of a tractor of the tractor-trailer combination vehicle; generating, by a reference governor, an output comprising a modified reference based on an input reference and the current state such that the dynamic system satisfies a constraint with a predefined probability, wherein the constraint is a maximum allowable lateral acceleration for the tractor-trailer combination vehicle to prevent a rollover, wherein the input reference is a predicted lateral acceleration at a future time period, and the current state is the current lateral acceleration; determining, by a feedback controller, a value of a control input based on the modified reference and the current state, wherein the control input is a steering angle for wheels of the tractor; and wherein the operations are implemented by a control system that is configured for preventing a rollover of the dynamic system.

According to an embodiment of the non-transitory computer-readable storage medium, which optionally includes any one or more of previous embodiments, the control system is configured as a data-driven model based control comprising an ultra-local model of the dynamic system.

According to an embodiment of the non-transitory computer-readable storage medium, which optionally includes any one or more of previous embodiments, the ultra-local model operates in background, estimating dynamics of the dynamic system while the tractor-trailer combination vehicle is in nominal operation in real-time.

According to an embodiment of the non-transitory computer-readable storage medium, which optionally includes any one or more of previous embodiments, the operations are configured to be used in a maneuver path with a risk of the rollover.

According to an embodiment, disclosed is a method comprising: obtaining real-time input-output data from a dynamic system using one or more sensors; estimating an ultra-local model of the dynamic system using a continuously updated low-order differential equation, wherein system dynamics, including nonlinearities and disturbances, are encapsulated in an estimated parameter; computing a control signal based on the ultra-local model, using a model-free control law that dynamically adjusts based on real-time estimations; and applying the control signal to an actuator of the dynamic system to achieve a desired system response while complying with predefined constraints; and wherein the method is implemented in a control system for controlling the dynamic system using the ultra-local model based control approach; and wherein a control strategy continuously updates in response to varying system conditions, thereby enabling adaptive performance across a range of operating environments; and wherein the method is configured as the control strategy to operate the dynamic system without reliance on a predefined mathematical model of the dynamic system.

According to an embodiment, disclosed is a method for a vehicle, comprising retrieving data from one or more sensors positioned on a tractor of the vehicle, wherein the tractor is mechanically coupled to a trailer forming a tractor-trailer system; determining, based on the data retrieved from the one or more sensors, a lateral acceleration parameter of the tractor; and controlling based on the lateral acceleration parameter of the tractor, via a controller, a steering angle of steered wheels of the tractor such that a lateral acceleration of the vehicle is held below a threshold lateral acceleration.

According to an embodiment of the method, which optionally includes any one or more of previous embodiments, the one or more sensors comprises an accelerometer.

According to an embodiment of the method, which optionally includes any one or more of previous embodiments, the controller comprises a data-driven model, and wherein the data-driven model comprises an ultra-local model.

According to an embodiment of the method, which optionally includes any one or more of previous embodiments, the ultra-local model is formulated such that a future state depends on a current state and a reference, wherein the current state is the lateral acceleration parameter of the tractor in a current time period and the reference is a lateral acceleration of the tractor predicted along a maneuver at an immediate future time period.

According to an embodiment of the method, which optionally includes any one or more of previous embodiments, the reference is modified by a reference governor for enforcement of a constraint on an allowable maximum lateral acceleration of the tractor-trailer system.

According to an embodiment of the method, which optionally includes any one or more of previous embodiments, the allowable maximum lateral acceleration of the tractor-trailer system is generated based on an amplification factor of the lateral acceleration from the tractor to the trailer.

According to an embodiment of the method, which optionally includes any one or more of previous embodiments, the reference governor receives the reference of the lateral acceleration parameter for a maneuver path from an Advanced Driver Assistance System (ADAS); and wherein the maneuver path is an obstacle avoidance path generated after sensing an obstacle along a current trajectory of the tractor-trailer combination vehicle.

According to an embodiment of the method, which optionally includes any one or more of previous embodiments, the reference governor is configured as a chance constrained reference governor such that the lateral acceleration parameter of the vehicle is held below the threshold lateral acceleration with a predefined probability, and wherein the predefined probability is in a range of 0.8 to 0.9999.

According to an embodiment of the method, which optionally includes any one or more of previous embodiments, the threshold lateral acceleration is selected such that rollover of one or more of the tractor and the trailer is avoided.

According to an embodiment of the method, which optionally includes any one or more of previous embodiments, the steering angle is controlled via an actuator configured to control an angle of the steered wheels; and wherein the method is configured to change a current state of the tractor-trailer system to a next state.

According to an embodiment, disclosed is a control system comprising: a sensor, and a feedback controller; the sensor configured to provide real-time data comprising a current state of a dynamic system, wherein the dynamic system is a tractor-trailer combination vehicle, and the current state comprises a current lateral acceleration of a tractor of the tractor-trailer combination vehicle; the feedback controller configured to determine a value of a control input based on a modified reference and the current state; and wherein the control system comprises a data-driven model, wherein the data-driven model comprises an ultra-local model of the dynamic system; and wherein the control system is configured to prevent a rollover of the tractor-trailer combination vehicle.

According to an embodiment of the control system, which optionally includes any one or more of previous embodiments, the ultra-local model configured to represent the dynamic system uses a low-order differential equation, and wherein the low-order differential equation is a first order differential equation.

According to an embodiment of the control system, which optionally includes any one or more of previous embodiments, the sensor comprises an accelerometer.

According to an embodiment of the control system, which optionally includes any one or more of previous embodiments, the control system further comprises a reference governor configured to output the modified reference based on an input reference and the current state such that the dynamic system satisfies a constraint, and wherein the constraint is a maximum allowable lateral acceleration for the tractor-trailer combination vehicle to prevent the rollover of one or more of the tractor and a trailer of the tractor-trailer combination.

According to an embodiment of the control system, which optionally includes any one or more of previous embodiments, the reference governor receives the input reference for a maneuver path from an Advanced Driver Assistance System (ADAS); and wherein the maneuver path is an obstacle avoidance path generated after sensing an obstacle along a current trajectory of the tractor-trailer combination vehicle.

According to an embodiment of the control system, which optionally includes any one or more of previous embodiments, the reference governor is configured as a chance constrained reference governor such that the modified reference satisfies the constraint with a predefined probability.

According to an embodiment of the control system, which optionally includes any one or more of previous embodiments, the input reference is a predicted lateral acceleration of the tractor at a future time period.

According to an embodiment of the control system, which optionally includes any one or more of previous embodiments, the control input is a steering angle for wheels of the tractor; and wherein an actuator is configured to receive and implement the control input changing the current state of the dynamic system to a next state.

According to an embodiment, disclosed is a method comprising: receiving, from a sensor, a real-time data comprising a current state of a dynamic system, wherein the dynamic system is a tractor-trailer combination vehicle, and the current state comprises a current lateral acceleration of a tractor of the tractor-trailer combination vehicle; determining, by a feedback controller of a control system, a value of a control input based on a modified reference and the current state, wherein the control system comprises a data-driven model, wherein the data-driven model comprises an ultra-local model of the dynamic system; and providing, the control input to an actuator of the dynamic system, such that the dynamic system changes from the current state to a next state; and wherein the method is implemented by the control system for preventing a rollover of the tractor-trailer combination vehicle.

According to an embodiment of the method, which optionally includes any one or more of previous embodiments, wherein the ultra-local model of the control system is formulated by estimating dynamics of the dynamic system in real-time while the tractor-trailer combination vehicle is in nominal operation.

### BRIEF DESCRIPTION OF THE FIGURES

The present disclosure is directed to various embodiments illustrated and described herein with reference to the various drawings, in which like reference numbers are used to denote like systems or assembly components, methods or algorithm steps. The illustrated components of the various systems are not necessarily drawn to scale.

FIG. 1A shows a current market solution for rollover prevention which requires an add-on Roll Stability Control (RSC) module to a trailer.

FIG. 1B shows a relationship between the rollover threshold gross vehicle mass according to an embodiment.

FIG. 2 shows an overview of the system view according to an embodiment.

FIG. 3A shows a table of results for rearward amplification of lateral accelerations in an avoidance maneuver by the Highway Safety and Truck Crash Comparative Analysis Technical Report by the U.S. Department of Transportation Federal Highway Administration according to an embodiment.

FIG. 3B shows Truck configurations and Weight scenarios analyzed according to an embodiment to get the data shown in FIG. 3A.

FIG. 3C shows a representative tractor-trailer lateral model according to an embodiment.

FIG. 4 shows a visual depiction of a reference governor that is implemented with an existing control system according to an embodiment.

FIG. 5 shows user specified parameters for the simulation according to an embodiment.

FIG. 6 shows the first experiment with β set to 0.85 according to an embodiment.

FIG. 7 shows the second experiment with β set to 0.995 according to an embodiment.

FIG. 8 shows the third experiment with β set to 0.9999 according to an embodiment.

FIG. 9 shows an output estimate of \hat{F}, The Kalman filter using a constant Q and R matrix which in essence acts as a low pass filter according to an embodiment.

FIG. 10 shows the steer angle output of the handwheel according to an embodiment.

FIG. 11 shows a Chance Constrained Reference Governor based on an Ultra-Local Model (CCRG-ULM) according to an embodiment.

FIG. 12 shows a flow chart for implementing the method for rollover prevention in truck-trailer combination according to an embodiment.

FIG. 13 shows a flow chart for implementing the method for rollover prevention in truck-trailer combination according to an embodiment.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

Unless defined otherwise, all technical and scientific terms used herein have the same meaning as commonly understood by one with ordinary skill in the art to which this disclosure belongs.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc. in question is or is not removable.

As used herein, the term “or” means an inclusive “or” rather than an exclusive “or.” That is, unless specified otherwise, or clear from context, “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Other specific forms may embody the present disclosure without departing from its spirit or characteristics. The embodiments described are in all respects illustrative and not restrictive. Therefore, the appended claims rather than the description herein indicate the scope of the disclosure. All variations which come within the meaning and range of equivalency of the claims are within their scope.

As used herein, the term “component” broadly construes hardware, firmware, and/or a combination of hardware, firmware, and software.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable storage medium for execution by, or to control the operation of, data processing apparatus. The computer-readable storage medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a stand-alone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of nonvolatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present disclosure may comprise or utilize a special purpose or general-purpose computer including computer hardware. Embodiments within the scope of the present disclosure may also include physical and other computer-readable media for carrying or storing computer-executable instructions and/or data structures. Such computer-readable media can be any media accessible by a general-purpose or special purpose computer system. Computer-readable media that store computer-executable instructions are physical storage media. Computer-readable media that carry computer-executable instructions are transmission media. Thus, by way of example and not limitation, embodiments of the disclosure can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general-purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general-purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIM), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general-purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multi-tasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the disclosure may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the disclosure. In a distributed system environment, program modules may be located in both local and remote memory storage devices.

As used herein “Machine learning” refers to algorithms that give a computer the ability to learn without explicit programming, including algorithms that learn from and make predictions about data. Machine learning algorithms include, but are not limited to, decision tree learning, artificial neural networks (ANN) (also referred to herein as a “neural net”), deep learning neural network, support vector machines, rules-based machine learning, random forest, etc. For clarity purposes, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model, improving the model's accuracy and performance over time.

Statistical modeling relies on finding relationships between variables (e.g., mathematical equations) to predict an outcome.

As used herein, a “sensor” is a device that measures physical input or a property from its environment and converts it into data that is interpretable by either a human or a machine. Most sensors are electronic, which presents electronic data, but some are simpler, such as a glass thermometer, which presents visual data.

In an embodiment, sensors may be removably or fixedly installed within the vehicle and may be disposed in various arrangements to provide information to the autonomous operation features. Among the sensors may be included one or more of a GPS unit, a Radio Detection and Ranging (radar) unit, a Light Detection and Ranging (LIDAR) unit, an ultrasonic sensor, an infrared sensor, an inductance sensor, a camera, an accelerometer, a tachometer, or a speedometer. Some of the sensors (e.g., radar, LIDAR, or camera units) may actively or passively scan the vehicle environment for obstacles (e.g., other vehicles, buildings, pedestrians, etc.), roadways, lane markings, signs, or signals. Other sensors (e.g., GPS, accelerometer, or tachometer units) may provide data for determining the location or movement of the vehicle (e.g., via GPS coordinates, dead reckoning, wireless signal triangulation, etc.).

The term “vehicle” as used herein refers to a thing used for transporting people or goods. Automobiles, cars, trucks, buses etc. are examples of vehicles.

The term “electronic control unit (ECU),” also known as an “electronic control module (ECM),” is a system that controls one or more subsystems. An ECU may be installed in a car or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with the automotive electronics.

As used herein, “Advanced Driver Assistance Systems (ADAS)” refers to a set of features and technologies integrated into vehicles to enhance driver safety, automate tasks, and to provide an improved driving experience. Examples of ADAS features include lane departure warning, adaptive cruise control, automatic emergency braking, and parking assistance. These systems often use sensors, cameras, radar, and other technologies to monitor the vehicle's surroundings and assist the driver in real-time. ADAS often involve the use of Electronic Control Units (ECUs), which are electronic components or embedded systems that control and manage various aspects of a vehicle's functions.

The term “autonomous vehicle” also referred to as self-driving vehicle, driverless vehicle, robotic vehicle as used herein refers to a vehicle incorporating vehicular automation, that is, a ground vehicle that can sense its environment and move appropriately with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

The term “maneuver” as used herein refers to moving, steering, or driving a vehicle from one point to another point.

The embodiments described herein can be directed to one or more of a system, a method, an apparatus, and/or a computer program product at any possible technical detail level of integration. The computer program product can include a computer-readable storage medium (or media) having Computer-readable program instructions thereon for causing a processor to carry out aspects of the one or more embodiments described herein. The computer-readable storage medium can be a tangible device that can retain and store instructions for use by an instruction execution device. For example, the computer-readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the Computer-readable storage medium can also include the following: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A Computer-readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire. A control system may be part of the ECU.

Computer-readable program instructions described herein are downloadable to respective computing/processing devices from a computer-readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives Computer-readable program instructions from the network and forwards the computer-readable program instructions for storage in a computer-readable storage medium within the respective computing/processing device. Computer-readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer-readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field programmable gate arrays (FPGA), and/or programmable logic arrays (PLA) can execute the computer-readable program instructions by utilizing state information of the computer-readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by Computer-readable program instructions. These Computer-readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These Computer-readable program instructions can also be stored in a computer-readable storage medium that can direct a computer, a programmable data processing apparatus and/or other devices to function in a particular manner, such that the computer-readable storage medium having instructions stored therein can comprise an article of manufacture including instructions which can implement aspects of the function/act specified in the flowchart and/or block diagram block or blocks. The Computer-readable program instructions can also be loaded onto a computer, other programmable data processing apparatus and/or other device to cause a series of operational acts to be performed on the computer, other programmable apparatus and/or other device to produce a computer-implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multi-processor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various Computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any data processing unit, computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read-only memory (ROM), programmable ROM (PROM), electrically programmable ROM (EPROM), electrically erasable ROM (EEPROM), flash memory, and/or nonvolatile random-access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The following terms and phrases, unless otherwise indicated, shall be understood to have the following meanings.

The term “Reference Governor,” as used herein refers to a supervisory control mechanism that dynamically adjusts the reference input to a control system to ensure constraint satisfaction while optimizing performance. It prevents the system from being commanded to operate beyond its physical or operational constraints. A Reference Governor continuously monitors the reference signal and modifies it, if necessary, to ensure that the system operates within specified bounds. This is particularly important in situations where the reference signal might be generated by an external source or a higher-level controller that may not be fully aware of the system's limitations.

The term “Ultra-Local Model,” as used herein refers to a data-driven control modeling approach that represents a system's dynamics using a simplified, real-time estimated model rather than a detailed first principles mathematical description. It may refer to a model used in control theory, particularly for designing controllers for complex systems. An ultra-local model \ captures the relation, using a mathematical model, between input (control signal) and the output (system response) within a limited scope of a dynamic system.

The term “dynamic system,” as used herein refers to a physical or engineering system that evolves or changes over time. It also refers to a mathematical or conceptual representation used to describe the behavior of the physical or engineering system in terms of its states, inputs, outputs, and the relationships among them.

The term “model-free” refers to a methodology that does not explicitly rely on an explicit mathematical model of the system under consideration. Instead of using a detailed understanding of the system's dynamics, a model-free approach learns the optimal control policy or behavior directly from data pertaining to the system or through interactions with the system. Hence these models are also referred to as data-driven models or data-based models.

The term “model-based” refers to a methodology that involves constructing mathematical models of the system's dynamics. These models may be used to design, for example, control strategies. These models describe the relationships between system inputs, outputs, and states using equations derived from first principles or empirical observations. These are also referred to as physics-based models, models based on first principles, or parameterized models. Such constructed models may be leveraged, for example, to analyze system behavior, predict future states, and design control algorithms that optimize performance and meet desired objectives.

The term “Roll Stability Control (RSC)” as used herein refers to an electronic system designed to enhance the roll stability of vehicles, particularly during dynamic maneuvers or emergency situations that might lead to a potential rollover. RSC systems are commonly found in modern vehicles, cars, trucks, and Sports Utility Vehicle (SUV) for preventing or mitigating the risk of rollovers.

The term “state constraints” as used herein refers to limitations or boundaries imposed on the allowable values of the system's states, which represent the internal variables describing the system's behavior. For example, a state constraint could specify that the lateral acceleration should not surpass a predefined value (e.g., 0.8 g) to avoid excessive lateral forces that might lead to a loss of control.

The term “control constraints” as used herein refers to restrictions placed on the allowable values of the control inputs or signals applied to the system. For example, a control constraint might restrict the steering rate to a certain value (e.g., 100 degrees per second) to prevent rapid and potentially destabilizing steering maneuvers.

The term “control law,” as used herein refers to a mathematical relationship that governs how the input signals to a system (often referred to as control inputs or control actions) should be adjusted or manipulated in response to the system's current state or output. A control law regulates the behavior of the system, ensuring that it behaves in a desired manner. A control law aims to adjust the system's behavior to minimize the difference between an actual output and a reference signal and may operate in a continuous or discrete manner, continually adjusting the control inputs based on the feedback from the system. Examples of common types of control laws include proportional-integral-derivative (PID) controllers, state-space controllers, and model predictive controllers, among others.

The term “lateral acceleration,” as used herein refers to a measure of the rate at which a vehicle or object is accelerating laterally, perpendicular to its forward motion. It describes the change in velocity in the sideways direction and is experienced when a vehicle makes a turn or changes its direction of travel. It is also referred to as transverse acceleration. Lateral acceleration is often experienced during maneuvers such as turning, cornering, or changing lanes. It is typically measured in units of acceleration (e.g., meters per second squared or g-forces, where 1 g is approximately equal to the acceleration due to gravity).

The term “tractor-trailer system,” as used herein refers to a semi-truck or articulated lorry, is a type of vehicle commonly used in transportation and logistics. It comprises two main components: a tractor (also called a truck or cab) and a trailer. It is in general referring to any vehicle with one or more trailers attached to it. It is also referred to as a tractor-trailer combination or a tractor-trailer combination vehicle.

The term “steering input,” as used herein refers to commands or signals provided to the steering system, either by a human driver or an automated control system, to guide the vehicle along a specified path or to respond to changing driving conditions. An input to the steering wheel changes the orientation of the front wheels, influencing the vehicle's trajectory and affecting the lateral motion.

The term “proportional control gain,” as used herein refers to a parameter used in control systems. Proportional control is a fundamental component of control theory, and it is commonly employed in various control systems to regulate the behavior of dynamic systems. In a proportional control system, the output of the controller is directly proportional to the error between the desired setpoint and the actual process variable. The control law can be expressed mathematically as Control Output=Kₚ×Error(e). The proportional control gain determines the strength or aggressiveness of the control action in response to the error.

The term “low-pass filter” as used herein refers to an electronic circuit or signal processing function that allows signals with a frequency lower than a certain cutoff frequency to pass through, while attenuating (reducing) signals with frequencies higher than the cutoff frequency. It allows low-frequency components to pass and attenuates high-frequency components. The cutoff frequency of a low-pass filter is a critical parameter that determines the point at which the filter starts to attenuate the input signal. Frequencies below the cutoff are considered “passed,” and frequencies above are “filtered out” or attenuated.

The term “controller,” as used herein refers to a device or component that manages and regulates the behavior of a system to achieve desired performance or meet certain criteria. The primary purpose of a controller is to manipulate the inputs or conditions of a system to influence its output or behavior. Controllers often incorporate a feedback mechanism, where the system's output is compared to a reference or desired value. The difference, known as the error, is used to adjust the system's inputs.

The term “Maximum Output Admissible Set,” as used herein refers to the set of all possible system states that result in the maximum allowable output given the constraints on the system.

The term “Constraint Admissible Set,” as used herein refers to the set of all possible states of a system that satisfy a given set of constraints. While the constraint admissible set focuses on ensuring that the system stays within predefined limits and adheres to specified constraints, the maximum output admissible set is concerned with determining the set of states that lead to the maximum permissible output while still satisfying those constraints.

The term “rollover” as used herein refers to a type of accident where a vehicle tips over onto its side or roof. Rollovers, for example, can occur when a vehicle loses balance, and the center of gravity shifts beyond a critical point, causing the vehicle to overturn. To “prevent rollover” or “avoid rollover” in the context of vehicle dynamics refers to implementing measures or strategies so that a vehicle does not rollover onto its side or roof during operation.

Rollovers are often caused by exceeding a critical lateral acceleration, a_{y}, threshold at which point the vehicle suspension cannot keep the trailer upright. Presently, many systems incorporate a mechanism on the trailer to gauge lateral acceleration. If the lateral acceleration surpasses a predefined threshold, the system activates the trailer brakes as a precautionary measure to prevent an obstacle in the path which the vehicle is following.

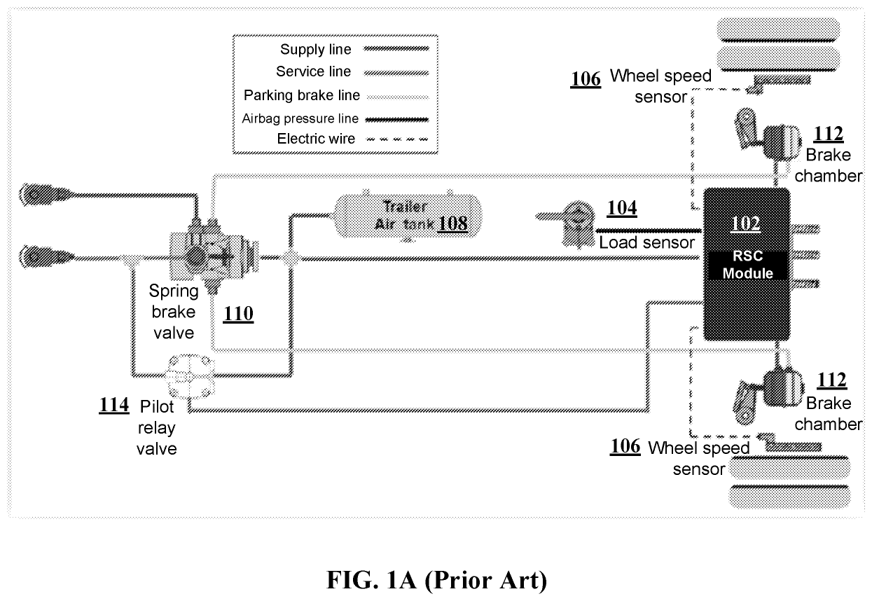

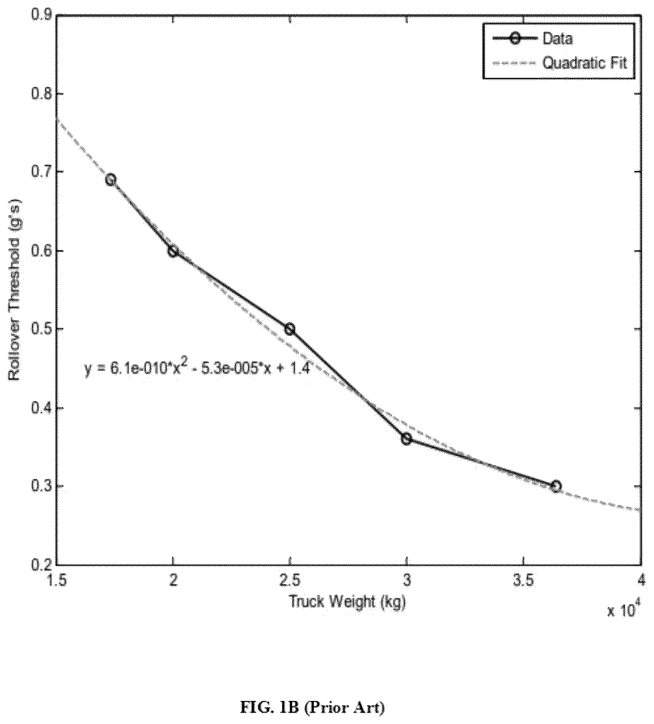

FIG. 1A shows a current market solution for rollover prevention which requires an add-on Roll Stability Control (RSC) module to a trailer. The add-on RSC module has a built-in inertial measurement unit (IMU) to measure lateral acceleration of the trailer and the trailer RSC module is usually installed underneath the trailer. The system will apply differential braking to reduce lateral acceleration if a certain threshold is exceeded. Current solutions on the market require the purchase of a Roll Stability Control (RSC) module for every trailer because of which cost/expenses would be prohibitive for many customers. RSC modules may have a built-in accelerometer to measure trailer acceleration. Such solutions are not practical when picking up and dropping off trailers for other companies/of different sizes and models.

The RSC module 102, embedded with an accelerometer is usually installed underneath the trailer and accessible to the sprung mass lateral acceleration. During operation, the air from trailer air tank 108, via both the supply and service lines, is used to charge the trailer's brake chambers 112 as commanded by the RSC module 102. The spring brake valve 110 supplies compressed air to the trailer brake chamber 112 to release the parking brake. In the event of trailer supply line failure, the trailer parking brake is automatically applied by the loaded spring inside the brake chamber 112. At the same time, the RSC module receives the service line pressure from the pilot relay valve 114, which is used to reduce the brake delay in a normal pedal brake application. As shown in FIG. 1A, the RSC module 102, the load sensor 104, wheel speed sensors 106, and an embedded accelerometer are indispensable parts that provide the information needed for the RSC control.

The RSC module continuously checks the trailer's lateral acceleration to detect the risk of rollover. The RSC module continuously checks if the lateral acceleration threshold falls below the RSC lateral acceleration first (low) threshold and when the lateral acceleration continues to increase and exceed a second (high) threshold, the RSC starts to apply the trailer brake to prevent the trailer rollover. The RSC module intervention ends after the trailer lateral acceleration reduces below the second (high) threshold. The RSC module continuously iterates the process to mitigate the risk of rollover. FIG. 1B shows a relationship between the rollover threshold and gross vehicle mass. When the RSC module detects a lateral control threshold, typically related to an estimated gross vehicle mass, it will activate the trailer brakes to reduce the velocity of the truck.

Therefore, there is a need for an approach to reduce rollover risk with no additional cost and/or add-on modules and further there is a need for an approach that is suitable/adaptable when trailers of various shapes and sizes are used with a vehicle or tractor.

In an embodiment, the system and method use a data-driven model to reduce rollover risk by modifying steering commands. An embodiment relates to a method of preventing tractor-trailer rollovers through the use of a chance constrained reference governor and a data-driven ultra-local model. This approach requires no modification to the trailer and no additional sensors/add-on modules.

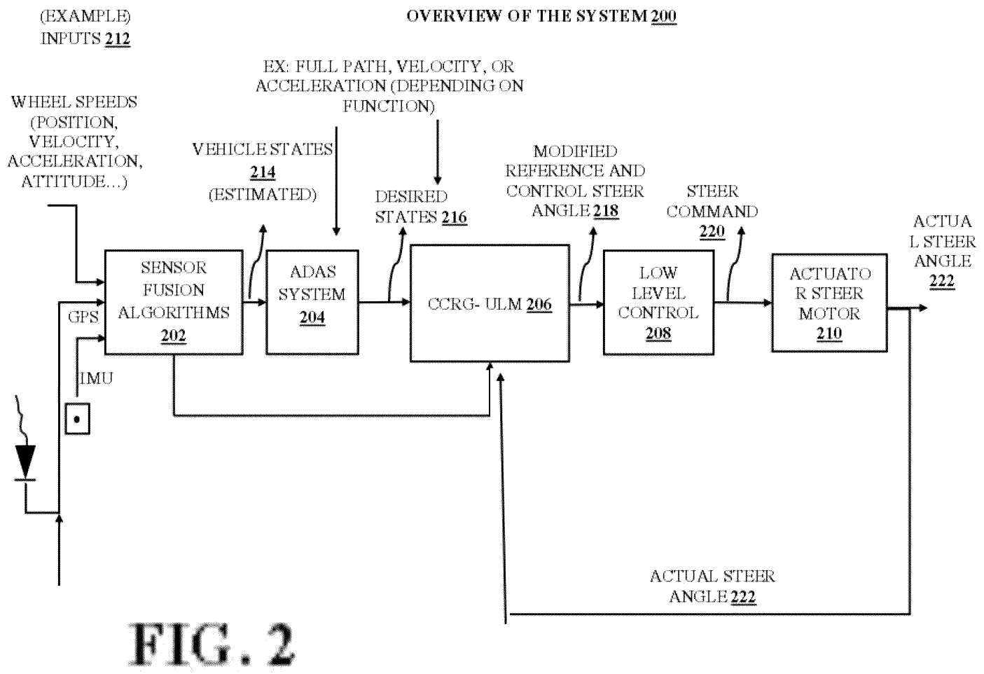

FIG. 2 shows an overview of the system view according to an embodiment. The system 200 comprises Sensor fusion algorithm/s 202, Advanced Driver Assistance System (ADAS) 204, Chance Constrained Reference Governor based on an Ultra-Local Model (CCRG-ULM) 206, Low-level control 208, and Actuator steer motor 210.

Sensor fusion algorithms 202 receives inputs 212, for example, wheel speeds, position, velocity, acceleration, attitude, Global Positioning System (GPS), inertial measurement unit (IMU), etc., from one or more sensors installed in the system. The inputs 212 may include direct data from the sensors and/or derived data from the sensor input and are used to determine a current state of the system. Considering the inputs 212, sensor fusion algorithms 202 process the inputs 212 and determines or estimates the vehicle states 214. These vehicle states 214, also referred to as current state of the system, are then provided as an input to ADAS 204. ADAS 204 then processes the vehicle states 214 and provides desired states 216 as an output that is received by the CCRG-ULM 206. Desired states 216 are considered as reference states by CCRG-ULM 206.

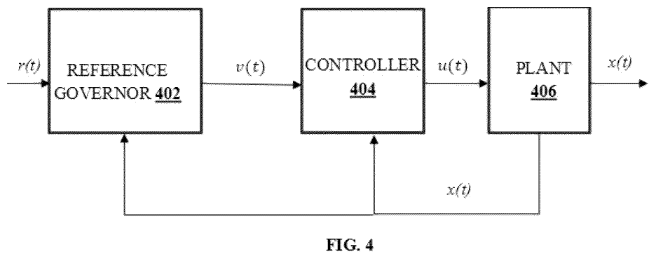

Chance Constrained Reference Governor based on an Ultra-Local Model (CCRG-ULM) 206 comprises a Chance Constrained Reference Governor and a Controller based on Ultra-Local Model (ULM), as shown in FIG. 4 and/or FIG. 11 which are further explained in their respective figure descriptions. According to an embodiment, ULM is a data-driven model and not a parameterized model. Data-driven models are constructed based on data collected directly from the system rather than relying on theoretical equations or first principles. Ultra-local model or data-driven model/s are used to capture the behavior of the system within a localized region with a high degree of accuracy and granularity. By focusing on the immediate effects of inputs and disturbances within this region. Data-driven models provide insights into the system's behavior and dynamics, allowing for more effective control. CCRG-ULM 206 considers the desired states 216, the feedback of the actual steer angle 222 to provide a modified reference and control steer angle 218, wherein the modified reference would satisfy the constraints placed on the system. An example of one such constraint is maximum allowable lateral acceleration to prevent a rollover. When there is no constraint/s violation, the desired states 216 would be the same as modified reference of modified reference and control steer angle 218. Control steer angle of modified reference and control steer angle 218 would then be fed as an input steer command 220 to low-level control 208. Low-level control 208 is configured for direct manipulation of actuators and control inputs to regulate the physical dynamics of a system. It is configured for direct implementation of control actions, such as adjusting steering angle based on the control steer angle. Once the control command is passed from low-level control 208 to actuator steer motor 210, the actuator steer motor performs the adjustment to the steer angle of the system and the system would realize actual steer angle 222. In this example, a change in steer angle would move the system to a new state which would then be fed back to CCRG-ULM 206 and as inputs 212. The inputs 212 would be influenced by the actual steer angle and the updated sensor readings will be fed as inputs 212 again to the system 200 to continuously analyze and control the system.

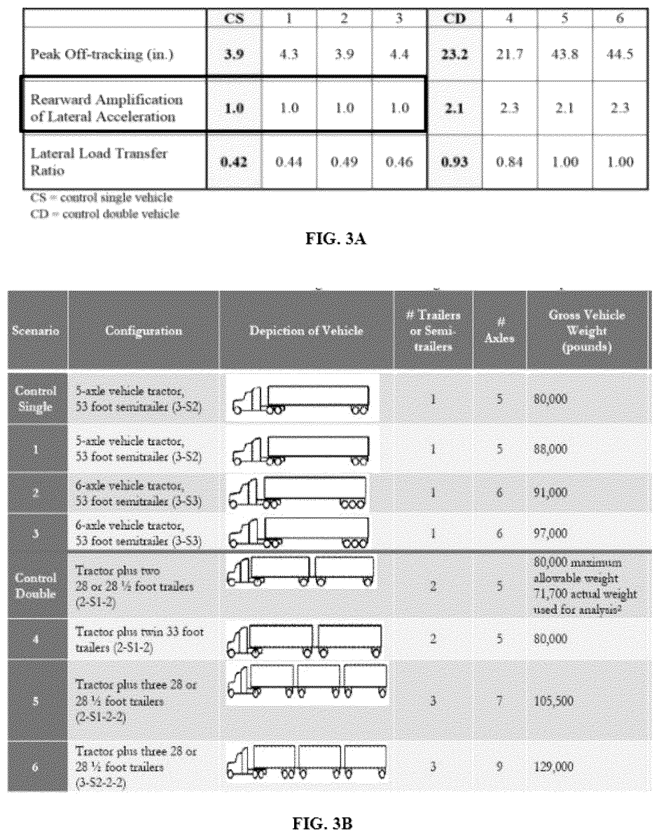

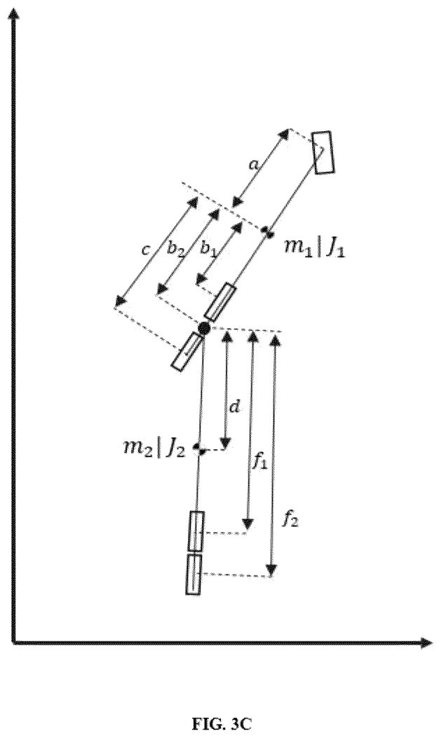

FIG. 3A shows results for rearward amplification of lateral accelerations in an avoidance maneuver by the Highway Safety and Truck Crash Comparative Analysis Technical Report by the U.S. Department of Transportation Federal Highway Administration according to an embodiment. The procedure to evaluate rearward amplification properties was based on the single lane change maneuver in International Organization for Standardization (ISO) 14791 (ISO 2000). FIG. 3B shows Truck configurations and Weight scenarios analyzed according to an embodiment to get the data shown in FIG. 3A. According to the report, for obtaining the rearward amplification of lateral acceleration, all avoidance maneuvers were run at 50 mph. Eight paths were drawn, each in the shape of a single lane change but with a different amount of lateral path change. For each path, the longitudinal distance of the transition was set so that, if the tractor exactly followed the path, its lateral acceleration would be a single cycle of a sine wave with a peak lateral acceleration of 0.15 gravitational units. How much the trailers responded to the steering would depend on how sudden the maneuver was (technically, the frequency of excitation). Eight lane change widths (3, 6, 9, 12, 15, 18, 21, and 24 ft.) were simulated for the avoidance maneuvers. Given these eight lane changes, the highest response (i.e. highest off-tracking, highest rearward amplification, and highest lateral load transfer ratio) for each vehicle is reported as shown in FIG. 3A. It shows that the rearward amplification of lateral acceleration from the tractor to the first trailer is 1.0 for a single trailer configuration. The relationship between the peak lateral acceleration of the tractor and the peak lateral acceleration of the trailer is called the rearward amplification ratio, from the tractor to the trailer, and for combination-single (CS), i.e., for a single trailer vehicle, it was found to be 1.0. This has rather profound implications as it means that in order to constrain the lateral acceleration of the trailer, for such single trailer vehicles below the critical threshold, a system does not need to be implemented on the trailer for rollover prevention, rather only the tractor lateral acceleration would need to be constrained due to the discovered rearward amplification ratio. Commercial RSC systems as described in FIG. 1A are rather reactionary, waiting for a critical threshold to be crossed before activation.

According to an embodiment, disclosed is a proactive approach which provides some guarantees that the critical threshold is never crossed. This will be accomplished by minimally modifying a desired reference path created by an ADAS or autonomy system. Many methods of constraint enforcement utilize model-based methods. Model predictive control is a commonly used model-based control method that allows for state and control signal constraint. Traditional Model Predictive Control (MPC) however does not account for model or measurement uncertainty.

FIG. 3A data may further mean that when a tractor's lateral acceleration is known, the trailer's highest rearward amplification in the lateral acceleration can be determined using such experimental results or studies. In an embodiment, a formal mathematical explanation of the maneuver and analysis may be used to find the trailer's highest rearward amplification in the lateral acceleration. In an embodiment, a data-driven model, such as a regression model, may be used to arrive at the highest rearward amplification in the lateral acceleration to each of the trailers attached to the tractor. In an embodiment, the regression models may be formed for varying sizes, shapes, maneuvers, maneuver conditions, and load conditions which may be used for arriving at rearward amplification in the lateral acceleration to each of the trailers.

Since the initial development of the Proportional-Integral-Derivative (PID) controller in the year 1910 automatic control has been a rapidly growing field. While there are many methods for implementing automatic control the entire field may be classified into two main categories: i) model-based control and ii) data-driven model based control. There are numerous uses for model-based control due to their practicality and ease of implementation and hence are used in many cases. For example, vehicle control, control of Unmanned Aerial Vehicles (UAVs), spacecraft etc. On the other hand, data-driven model based control techniques are also gaining their use as onboard computing is becoming more powerful and systems are becoming more complex and harder to develop accurate models. If a model for the system is hard to obtain or unknown, then the model-based methods of constraining the system become intractable. FIG. 3C shows a representative tractor-trailer lateral model according to an embodiment. For tractor-trailer systems, a lateral vehicle model with neglected roll dynamics commonly has the form shown in FIG. 3C which has 16 uncertain parameters if tire cornering stiffness values are considered. Due to the challenge of estimating the model parameters it would be difficult to provide any real guarantee of constraint enforcement.

According to an embodiment, an Ultra-Local Model (ULM) is used for data-driven model based control. According to an embodiment, intelligent PID (i-PID) control which utilizes an Ultra-local Model (ULM) is used for data-driven model based control.

Whether systems use model-based or data-driven model based control methods, it has to be ensured that the control law used in the systems respects various state and control constraints. According to an embodiment, this may be accomplished through Model Predictive Control (MPC) or through the use of Reference Governors (RG). These methods, however, are not always robust to unmodeled disturbances which may cause the system to violate a constraint. Therefore, MPC systems use Robust MPC (RMPC) to handle bounded disturbances, and Chance Constrained MPC (CMPC) to handle unbounded stochastic disturbances. Similarly, reference governors can handle bounded disturbances and have even been used in model-free i-PID systems. Additionally, reference governors have been used to handle stochastic disturbances when there is a known system model.

According to an embodiment, a reference governor is provided with capabilities to handle unbounded stochastic disturbances using a data-driven model or Chance Constrained Reference Governor based on an Ultra-Local Model (CCRG-ULM). Though there exists a similarity in the framework of CCRG-ULM to the i-PID approach, CCRG-ULM is different in that it considers unbounded stochastic disturbances that would be encountered in practice such as estimation errors or external disturbances such as wind.

According to an embodiment, it is a method of enforcing chance constraints on a system with input-output dynamics modeled using data-driven models. According to an embodiment, an Ultra-Local Model (ULM) is used for estimating the input output dynamics of the system. The ultra-local model lumps all the internal dynamics and disturbances acting on the system into a single term that is estimated in real-time. This lumped dynamics/disturbances term is then used as a feed-forward term in the implemented control law with the desired system dynamics defining the rest of the control law. Using the now known system dynamics, chance constraints can be formulated to enforce state constraints in the presence of unbounded stochastic disturbances.

A test experiment was performed on a tractor-trailer system where the lateral acceleration of the tractor was to be limited or constrained. TruckSim®, a high-fidelity simulator, was used for testing the chance constraints and the model successfully limited the lateral acceleration below the specified constraint value.

Reference Governors: A reference governor is an add-on scheme for augmenting an existing control system with the capability of handling constraints. FIG. 4 shows a visual depiction of a reference governor that is implemented with an existing control system according to an embodiment. The control system comprises a reference governor 402, a controller 404, and a plant/system 406. Reference governor 402 takes in a high-level control reference command, r(t), and outputs a minimally modified reference, v(t). The modified reference is chosen in such a way that the system does not violate any state or actuation constraints. When the input reference does not cause any constraint violations, then the reference governor simply passes through the high-level reference and v(t)=r(t).

To understand the exact function of the reference governor it is necessary to understand safe sets. For traditional reference governors continuous or discrete system dynamics are defined by (1)-(2) where w(t)∈W is a bounded disturbance provided.

$$x ( t + 1 ) = f ( x ( t ) , v ( t ) , w ( t ) ) \qquad ( 1 )$$

$$y = h ( x ( t ) , v ( t ) ) \qquad ( 2 )$$

The safe set is then defined to be the set of all initial states and constant reference signals, x₀, and v_{T}, such that there will be no violation of a state or actuation constraint. Formally, this safe set is often referred to as the Maximum Output Admissible Set (MOAS) and is defined by (3)

$${O}_{∞} = \{ ( v , {x}_{0} ) : x ( t ) ∈ X , u ( t ) ∈ U ∀ t \geq 0 \} \qquad ( 3 )$$

where X and U are the allowable states and actuation commands/control values respectively. That is, the MOAS O_{∞} represents the set of reference-initial condition pairs that are safe in terms of ensuring that x(t)∈X and u(t)∈U for all time. If MOAS can be calculated, the reference governor online optimization problem can be formulated as shown in (4) which is often a convex quadratic program and hence is easy to solve.

$${arg {min}_{v} \vert \vert v - r ( t ) ‖}^{2} \qquad ( 4 )$$

$$s . t . ( {x}_{t} , v ) ∈ {O}_{∞}$$

If a model describing the system dynamics is at hand, a MOAS O_{∞} or a close approximation can be constructed using a model-based approach. In particular, when the system is subject to unmeasured disturbances, a robust version of O_{∞} may be calculated assuming the disturbance takes values in a known bounded set and used by the reference governor. Alternatively, when the disturbance has some statistics and is assumed to follow some known probability distribution (e.g. Gaussian), a stochastic version of O_{∞} may be considered. In this stochastic version the constraints (e.g. x(t)∈X) are enforced up to a prescribed probability level (e.g. P(x(t)∈X)≥β, often referred to as chance constraints. However, for systems with unknown or hard-to-model dynamics, typical model-based approaches are not directly applicable.

In order to ensure constraint satisfaction even in the presence of the bounded disturbance w(t) the admissible set X must be tightened. This tightening is accomplished through the use of the Pontagryin-difference, also called the P-difference. The P-difference is a set operator denoted by “˜” and is formally defined in (5) as

$$A ∼ B = \{ c : c + b ∈ A ∀ b ∈ B \} \qquad ( 5 )$$

Therefore, the method of determining the admissible state set for a linear system at each point-wise moment in time where X_{t,0}=X, is presented by (6) as

$${X}_{t \vert k + 1} = {X}_{t \vert k} ∼ {Φ}^{k} W \qquad ( 6 )$$

where Φ is the state transition matrix.

Equations (5)-(6) reveal the importance of W being bounded. If the disturbance were unbounded and stochastic such as the Gaussian distribution the output of the P-difference would be the null set even if the probability of getting a large disturbance were near zero. Unfortunately for the P-difference method of constraint enforcement many practical disturbances are modeled as Gaussian random variables such as estimator error.

For systems with unknown or hard-to-model dynamics, typical model-based approaches are not directly applicable. For such systems, the current application discloses a system and a method for designing a reference governor and enforcing constraints based on a data-driven Ultra-Local Model (ULM) of unknown dynamics and to incorporate chance constraints. Further, the system and/or the method is applied to a tractor-trailer constrained control problem.

Ultra-Local Model (ULM): The ULM is a powerful, data-driven model that may be used for system control whose underlying model is unknown or hard-to-model. For a single-input-single-out (SISO) system with input u and output y can be expressed using ULMs which typically take the form of (7) as

$${y}^{( n )} = F + α u \qquad ( 7 )$$

where F is an estimated parameter and α is a non-physical constant. The parameter α is typically selected to make F and au be roughly the same in magnitude. The parameter F is estimated according to (8)

$$\hat{F} = {y}^{( n )} - α u \qquad ( 8 )$$

Because the parameter F is calculated using the nth-order derivative of the desired signal, F contains the information of the process being controlled without any assumptions regarding the relationships of the states or their linearity. While the estimation of F is not the focus, an algorithm presented herein from prior art guarantees convergence to within a region of zero error.

F can be estimated directly through continuous time or discrete time methods. Additionally, updates to the state estimate can utilize a linear or nonlinear method, resulting in differing degrees of accuracy in the final estimate. In examples, a discrete time technique using a holder-continuous update may be employed, as herein described.

Begin by calculating the current value of F using (9)

$${F}_{k} = {y}^{( n )} - α u \qquad ( 9 )$$

then calculate the estimated error by (10)

$${e}_{k}^{F} = {\hat{F}}_{k} - {F}_{k} \qquad ( 10 )$$

Finally, apply the nonlinear observer for Fₖ using equation (11)

$$\begin{matrix}{\hat{F}}_{k + 1} = {F}_{k} + D ( {e}_{k}^{F} ) \\ With D ( {e}_{k}^{F} ) = \frac{{( {( {e}_{k}^{F} )}^{T} {e}_{k}^{F} )}^{1 - \frac{1}{r}} - λ}{{( {( {e}_{k}^{F} )}^{T} {e}_{k}^{F} )}^{1 - \frac{1}{r}} + λ}\end{matrix} \qquad ( 11 )$$

Once F has been estimated the feedback control law described by (12)

$$u = \frac{{y}^{( n ) *} - {\hat{F}}_{k} - {K}_{p} {e}_{y}}{α} \qquad ( 12 )$$

Where y⁽ⁿ⁾* is the derivative of the reference signal, kₚ is a proportional control gain, and e_{y}=y−y_{ref} is the state error. This desired control law will yield a stable first order system response such as (13) where ε=Fₖ−\hat{F}ₖ.

$${\dot{e}}_{y} + {k}_{p} {e}_{y} = ε \qquad ( 13 )$$

Similar to single-input-single-output systems, in an embodiment, ULMs can be formulated for single-input-multiple-output systems. According to an embodiment, by measuring lateral acceleration, a control action can be taken on both steering and braking, which could prevent a rollover. An interplay between the steering and braking to prevent rollover can be developed for systems where steering alone may not accomplish a desired objective. In further embodiments, multiple input multiple output based ULMs may also be formulated based on the requirements and objectives of the system control.

Chance Constrained Reference Governor: Unlike traditional methods of enforcing constraints with strict linear or nonlinear inequalities such as in (14)

$$A x \leq B \qquad ( 14 )$$

chance constraints take a probabilistic approach to constraint enforcement. Generally, chance constraints can be defined by (15)

$$P ( G x \leq g ) \geq β \qquad ( 15 )$$

where the probability of violating the constraint is less than or equal to the value of β where β∈]0, 1[.

Propagating the Mean and Covariance: In order to form the chance constraint, the mean and covariance of the state must be propagated. For this paper it will be assumed that a first order ULM controller was selected yielding a discrete time model (16)

$${x}_{k + 1} = Φ {x}_{k} + B {x}_{r e f} + w \qquad ( 16 )$$

where w˜N(0, σ²) is a Gaussian disturbance acting on the system. Propagating the model forward in time to get the mean as shown in (17)

$${\overline{x}}_{k + 1} = {Φ}^{k} {\overline{x}}_{k} + {\sum }_{i = 0}^{k - 1} {Φ}^{k - i - 1} B {x}_{ref \vert k} \qquad ( 17 )$$

The mean of the function is therefore unaffected by the stochastic disturbance and only impacted by the selected reference signal. Since xₖ₊₁=xₖ at steady-state one can define the relationship between the reference and steady-state value to be (18) as

$${\overline{x}}_{s s} = {( I - Φ )}^{- 1} B {x}_{r e f} \qquad ( 18 )$$

Finally, the covariance of the system is also propagated. Given that the covariance at the current time is defined to be (19)

$${P}_{k} = E ( {x}_{k} - {μ}_{k} ) {( {x}_{k} - {μ}_{k} )}^{T} \qquad ( 19 )$$

which can be rewritten as (20)

$${P}_{k} = E [ {Φ}_{k - 1} ( {x}_{k - 1} - {m}_{k - 1} ) {( {x}_{k - 1} - {m}_{k - 1} )}^{T} {Φ}_{k - 1}^{T} + {w}_{k - 1} {w}_{k - 1}^{T} ] \qquad ( 20 )$$

where (20) assumes that the cross-correlation terms are zero. Finally, by (19) and defining E[wₖwₖ^{T}]=Qₖ, one can get the final covariance propagation equation (21)

$${P}_{k} = Φ {P}_{k - 1} {Φ}^{T} + Q \qquad ( 21 )$$

which assumes that the initial covariance P₀ is known. The covariance Pₖ will eventually converge to a steady-state covariance value Pₛₛ which can be found by solving the continuous Lyapunov equation (22)

$$Φ P {Φ}^{T} - P + Q = 0 \qquad ( 22 )$$

which assumes continuous dynamics from (13). A useful characteristic of (22) is that regardless of the initial starting covariance Pₛₛ will converge to the same value. If the initial covariance is sufficiently large then it is possible that the system is already violating some specified constraint.

Formulating the Chance Constraint: The chance constraint formulation in (15) can be written for individual constraints as (24)

$$P ( {G}_{i} {x}_{k \vert t} \leq {g}_{i} ) \geq β \qquad ( 23 )$$

which is rewritten as

$${ϕ}_{k \vert t} ( {g}_{i} ) \geq β \qquad ( 24 )$$

where ϕ_{k|t} is the Cumulative Density Function (CDF) N(Gᵢx̅_{k|t}, GᵢP_{k|t}Gᵢ^{T}). This can be normalized to use the standard normal distribution CDF, ϕ, by writing (24) as (25)

$$ϕ ( \frac{{g}_{i} - {G}_{i} {\overline{x}}_{k \vert t}}{\sqrt{{G}_{i} {P}_{k \vert t} {G}_{i}^{T}}} ) \geq β \qquad ( 25 )$$

Through a rearrangement of the terms in (24) an inequality on the mean value of the state can be constructed as in (26)

$${G}_{i} {\overline{x}}_{k \vert t} \leq {g}_{i} - \sqrt{{G}_{i} {P}_{k \vert t} {G}_{i}^{T}} {ϕ}^{- 1} ( β ) \qquad ( 26 )$$

which provides the point-wise in time chance constraints for the reference governor. However, because of the selection of the control law in (12) a further simplification can be made. If the control law implemented with the ULM results in a first order response, then satisfaction of the constraint can be guaranteed for all time if the steady-state conditions satisfy equation (26). Substituting (18) for x̅_{k|t} in (26) the steady-state inequality can be calculated to be (27).

$${x}_{ref} \leq {( {G ( I - Φ )}^{- 1} B )}^{- 1} ( {g}_{i} - \sqrt{{GP}_{ss} {G}^{T}} {ϕ}^{- 1} ( β ) ) \qquad ( 27 )$$

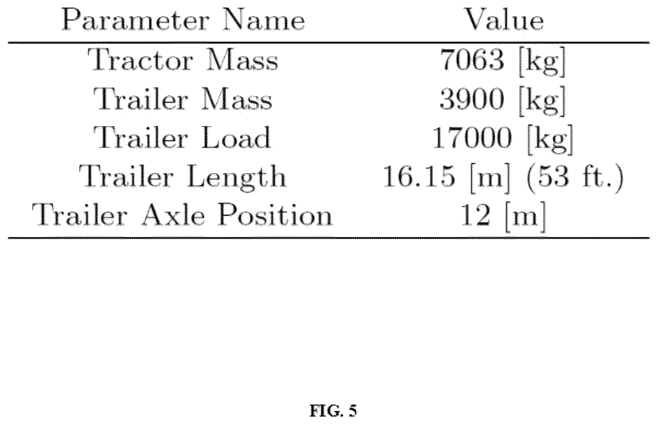

By enforcing this inequality on higher level reference commands like those seen in FIG. 5 certain guarantees on constraint enforcement can be made. This guarantees a probability of constraint enforcement greater than β. This inequality is enforced through an optimization problem defined in (24)

$$arg {min}_{v} {‖ v - {x}_{ref} ‖}^{2} \qquad ( 28 )$$

$$s . t . ( v ) ∈ {O}_{∞}$$

where O_{∞} is the region defined by (27).

### EXAMPLES

In an embodiment, testing of the Chance Constrained Reference Governor based on an Ultra-Local Model (CCRG-ULM) is performed in a simulated experiment. The CCRG-ULM is used to control and constrain the lateral acceleration of a class 8 tractor-trailer combination vehicle. This system was selected because the high-level of parameter variability poses a real challenge for many model-based control methods. A high-fidelity simulation environment, TruckSim®, was used in this testing.

Experimental Setup: The goal of this experiment is to limit the lateral acceleration of the tractor-trailer system to less than 1 m/s². The true nonlinear model of the system is unknown, and the system states are propagated within the TruckSim® environment. FIG. 5 shows user specified parameters for the simulation according to an embodiment. It comprises tractor mass, trailer mass, trailer load, trailer length, and trailer axle position.

Only one measurement was used by the ULM, a noisy measurement of the TruckSim® lateral acceleration, a_{y}. A Kₚ value was selected to provide a settle time of 5 seconds for the system. The TruckSim® a_{y} was corrupted by an additive Gaussian disturbance N˜(0, 2). The output from TruckSim® is sampled at 100 Hz which is in line with many real-world Inertial Measurement Units (IMU). A variance of 2 m/s² was chosen because of the levels of noise seen during previous experiments. The ULM actuator u is the hand wheel steering angle. Even though the CCRG-ULM approach allows for constraints on the allowable actuation signal, no steering constraints were applied in these simulations.

In order to test the efficacy of this method three different values were selected for B. For validation of this method, it would be expected that the probability of successful constraint enforcement be greater than or equal to the value of β for each selected run. Three β values were selected to test different cases which were β=[0.85, 0.995, 0.9999].

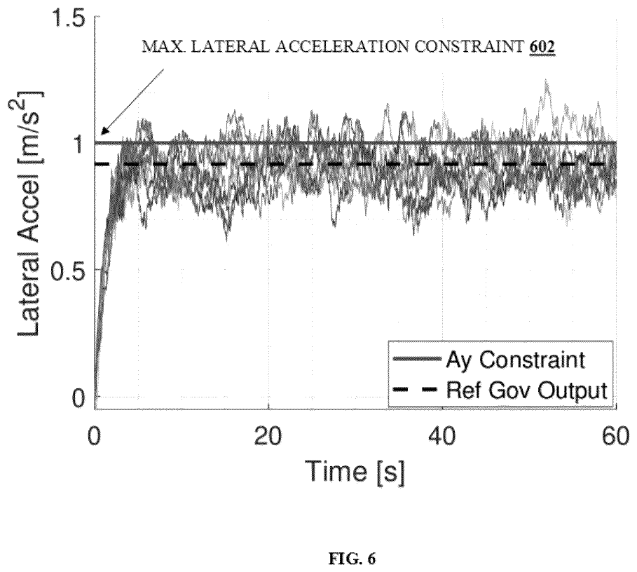

Simulation Results: FIG. 6 shows the first experiment with β set to 0.85 according to an embodiment. A total of 10 runs were performed and the results are plotted as shown in FIG. 6.

In each run the lateral acceleration reference was set to 1 m/s². Additionally, the constraint to be enforced is to keep the lateral acceleration of the truck below 1 m/s² even in the presence of the corrupted a_{y} measurement. To provide an 85% chance of not exceeding the limit of 1 m/s² for lateral acceleration or to enforce the limit of 1 m/s² as maximum lateral acceleration, the CCRG-ULM changes the reference signal from 1 to 0.9171. From the 10 runs the average probability of constraint enforcement was P_{CE}=0.8673 which is greater than the desired P_{des}=0.85. The limit is shown as maximum Lateral acceleration constraint 602.

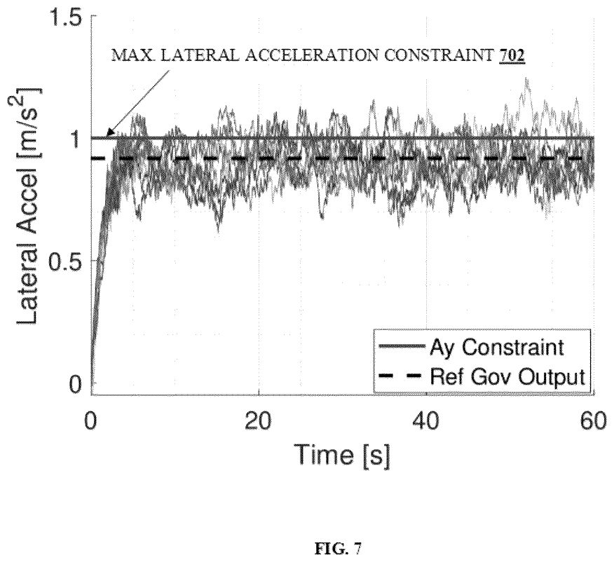

FIG. 7 shows the second experiment with β set to 0.995 according to an embodiment. To enforce this constraint the reference governor is much more aggressive and lowers the reference a_{y} down from 1 to 0.7866. On an average from 12 runs the CCRG-ULM had a constraint enforcement success rate of P_{CE}=0.9914 which is just lower than the desired P_{des}=0.995. It is worth noting that the measurement P_{CE} is a sampled average and not the true average. Given that P_{CE} is within 0.0036 of P_{des} this run is also considered successful. The limit is shown as maximum Lateral acceleration constraint 702.

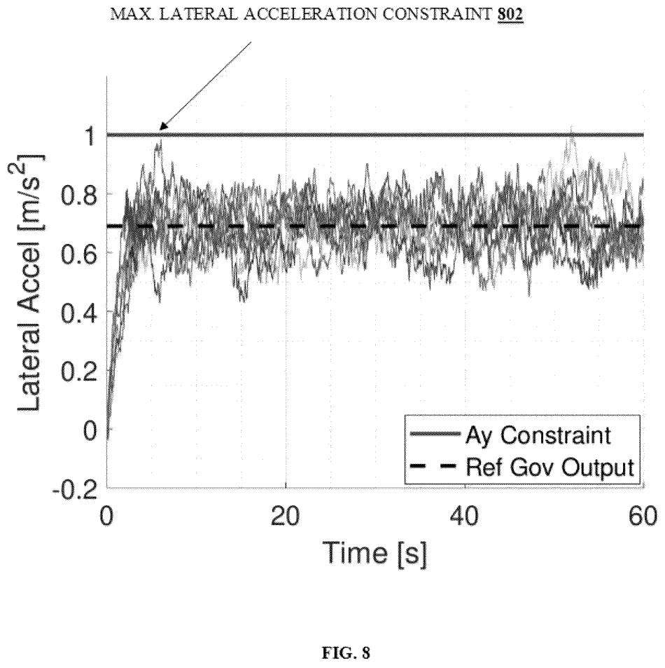

FIG. 8 shows the third experiment with β set to 0.9999 according to an embodiment. The CCRG-ULM adjusted the input reference down from 1 to 0.6896 to enforce the a_{y} constraint. From a sample size of 10 runs the probability of constraint enforcement was P_{CE}=0.09997 where P_{des}=0.9999. Again, with P_{CE} only being a sampled average and only being 0.0003 away from P_{des} this was considered a successful experiment. The limit is shown as maximum Lateral acceleration constraint 802.

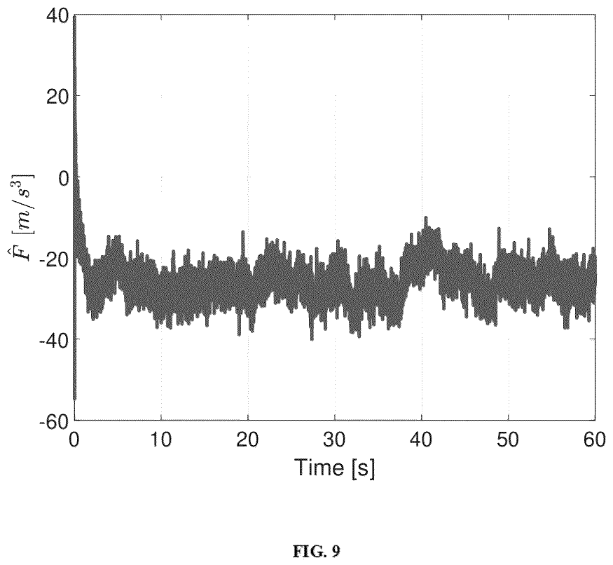

While the focus is on the constraint enforcement using the CCRG-ULM the control actuation is also important to analyze. In order to get a reasonable estimate of \hat{F} a Kalman filter was applied, the measurement a_{y} before being sent into the estimation algorithm for F. The Kalman filter used a constant Q and R value of 0.001 and 1.996 respectively. Because Q and R are constants, the Kalman filter in essence acts as a low pass filter. FIG. 9 shows an output estimate of \hat{F}, by the Kalman filter using a constant Q and R matrix which in essence acts as a low pass filter according to an embodiment.

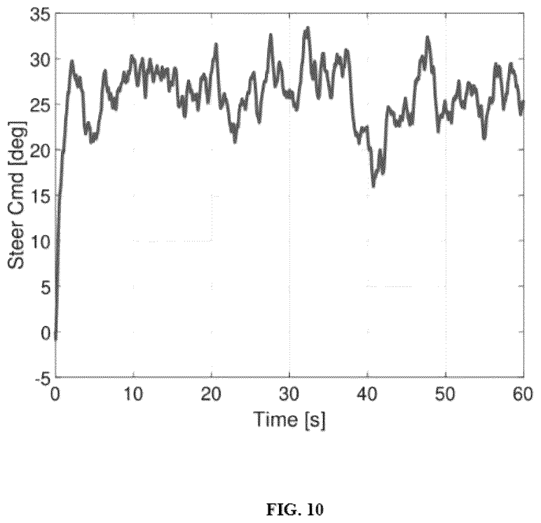

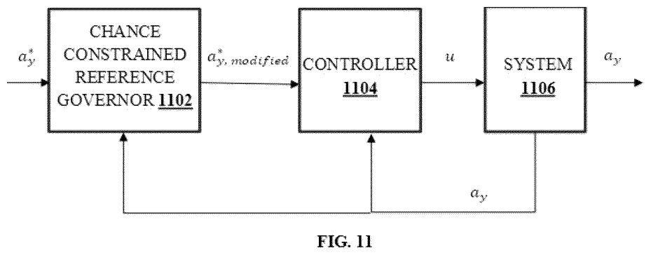

With the output of the ultra-local model (ULM) estimator being somewhat noisy it is reasonable to expect that the control output u was also noisy since \hat{F} is used directly as a feed-forward term. This is not an issue due to the nature of the steering subsystem having a dynamic response equivalent to that of a low pass filter. Therefore, the final control actuation is realizable by a tractor-trailer system. FIG. 10 shows the steer angle output of the handwheel from the simulations according to an embodiment.

According to an embodiment, disclosed is a method using chance constraints with an ultra-local model (ULM) to guarantee a specified level of roll stability for unmodeled systems. The ULM was used to estimate the unknown dynamics and provide the desired first order system response. The known dynamics input by the ULM were then used as the basis for implementing a reference governor for constraint enforcement. Due to the stochastic nature of estimator error and other external disturbances a chance constrained reference governor was used. This led to the implementation of the CCRG-ULM which demonstrated constraint enforcement equal to that specified by the user input β.

In an embodiment, a more sophisticated method of estimating a_{y}, the variance of the signal is reduced which would reduce the steady-state covariance value Pₛₛ resulting in less conservative behavior. In an embodiment, hardware of a vehicle is configured to implement the method to enforce state constraints on systems with unknown dynamics.

In an embodiment, disclosed is a system and a method for performing an evasive maneuver with a vehicle-trailer combination to avoid an obstacle in the path which the vehicle is following while simultaneously maintaining the stability of the vehicle-trailer combination during the evasive maneuver. According to an embodiment, the evasive maneuver is configured for steering around an obstacle.

In an embodiment, an evasion trajectory is determined along which the vehicle-trailer combination is moved in an automated manner, in order to evade an obstacle in the path which the vehicle is following. During the evasive maneuver a reference lateral acceleration of the vehicle-trailer combination is determined, and an output steering angle is determined such that the current lateral acceleration is below a maximum lateral acceleration.

Automated movement of the vehicle-trailer combination along the evasion trajectory is to be understood in this case to mean that active intervention is performed in the steering procedure, in that the desired steering angle is specified in an automated manner in order to follow an evasion trajectory. As a result, the vehicle-trailer combination is controlled to steer around a detected obstacle in a manner that ensures a threshold acceleration of the vehicle-trailer combination is not exceeded.

In an embodiment, the reference governor outputs, using a control law, a steering angle such that the maximum lateral acceleration is not exceeded.

In an embodiment, maximum lateral acceleration is determined from a rollover threshold, wherein the rollover threshold is determined based on a lateral acceleration from a device/sensor in the vehicle on vehicle-trailer combination and an amplification factor in the lateral acceleration from the vehicle to the trailer for preventing the vehicle-trailer combination from rollover. Such a sensor/device may be part of the stability control system. The rollover threshold may be by way of example a constant, for example less than about 3 m/s², or less than about 2 m/s², or less than about 1 m/s², or depending upon the vehicle may be determined for preventing the vehicle-trailer combination from rollover. In an embodiment, the maximum lateral acceleration may be updated in real-time. In an embodiment, an amplification factor is determined based on consideration to various shapes, sizes, loading capacities, and maneuver parameters of the vehicle-trailer combination. For example, considering data from FIG. 3A, for a tractor with 2 trailers as shown in scenario Control Double (CD) under column heading 4, the amplification factor could be considered as 1/2.3.

In an embodiment, the reference lateral acceleration of the evasive maneuver path is determined from the second derivative of the function of the respective evasion trajectory at a vehicle-x-position. In another embodiment, the reference acceleration is provided by Advanced driver assistance systems (ADAS) system.

While steering around an obstacle, the semi-truck/vehicle-trailer system may pose a risk of rollover. According to an embodiment, the disclosure relates to methods to ensure the vehicle-trailer system remains stable throughout the process of evasive maneuver while steering around.

According to an embodiment, the system and method are an approach for modifying steering input on the tractor of the tractor-trailer combination vehicle.

According to an embodiment, there exists a driver assistance or autonomy system on a vehicle capable of recognizing an obstacle in the path which the vehicle is following. The Advanced Driver Assistance System (ADAS) or autonomy system, is presumed to identify an obstacle and the system devises a trajectory to navigate around the obstacle. According to an embodiment, the current disclosure examines planned trajectory and utilizes it as a reference path.

In an embodiment, the system and/or method receives and/or determines the target positions, velocities, and accelerations for the truck on the trajectory or evasive maneuver provided by a higher-level path planning system such as ADAS. Upon receiving the path, Reference Governor based control system provides steering inputs as a function of lateral acceleration and controls so that lateral acceleration never exceeds a set threshold. Adjusting the steering can in turn cause the path to be modified minimally to create an updated path. Maximum lateral acceleration permissible before a truck would rollover, according to an embodiment, may be obtained from previous existing studies, literature, models, or mathematical formulations.

In an embodiment, maximum lateral acceleration permissible is established as a constraint and the system is directed using CCRG-ULM to adhere to the trajectory while ensuring it does not exceed a specified lateral acceleration. Adjustments were made to the path just adequately via steering input commands to prevent a truck rollover during the maneuver.

In an embodiment, the disclosed approach does not require to input/consider model-based assumptions, where factors such as the mass of the tractor and trailer, braking capabilities, and center of gravity are assumed to be known. In reality, the multitude of these parameters makes it challenging to construct an accurate model and relying on such a model lacks certainty in avoiding violations of the lateral acceleration constraint. In an embodiment, the disclosed system and method are applicable for real-time control of a passenger vehicle to prevent rollover including sports utility vehicle (SUV) or the like having higher Center of Gravity (CoG) or any other personal vehicle or commercial vehicle.

According to an embodiment, a data-driven model is incorporated to approximate the system dynamics using the ultra-local model. This methodology eliminates the need for predefined assumptions about the vehicle's dynamics model. By utilizing real-time data, a data-driven model is constructed predicting the future system states without relying on predetermined notions about the vehicle's dynamics. Once the reference or obstacle avoidance path is generated, the reference governor acts on top to control steering so as to ensure the lateral acceleration does not exceed a set limit. Rather than evaluating a rollover risk, the system proactively uses sensor data to prevent the rollover threshold from being exceeded.

Although reference governors exist in prior art, many limitations are prevalent in previous approaches. Most existing reference governors are designed to handle disturbances that are bounded. When faced with uncertainties, such as wind disturbances or stochastic disturbances from estimators detailing current position, velocity, and acceleration, these methods fall short. According to an embodiment, a reference governor capable of effectively managing stochastic disturbances, such as position estimation errors or wind disturbances is developed. This is integral to the overall functioning of the system. This is enabled via a data-driven model, assuming no pre-established model of the semi-truck. Once the ultra-local model provides a numerical approximation of the system dynamics, a reference governor is employed. The designed reference governor is capable of handling unbounded disturbances, distinguishing it from other existing methods.

According to an embodiment, the reference governor is enabled to work with a system model whose dynamics are known and modeled.

According to an embodiment, the process disclosed involves obtaining an obstacle avoidance maneuver path as an input to the system. From that provided path, Reference Governor is designed to ensure rollover avoidance by comparing reference lateral acceleration with the maximum lateral acceleration limit during the maneuver. According to an embodiment, the system functions to ensure obstacle avoidance during execution of the modified path.

According to an embodiment, the ultra-local model operates in the background, estimating the system dynamics while the truck is in normal operation. The ultra-local model necessitates the measurement of the state intended for control, which, in this instance, involves the measurement of lateral acceleration. The control input utilized to manage this state is the steering angle. Consequently, the ultra-local model relies solely on the measurement of the steering angle and lateral acceleration. This choice of ultra-local model and reference governor method accommodate stochastic errors inherent in any estimation process. Unlike existing reference governor methods, which demand bounded errors, the current approach can effectively handle stochastic unbounded errors.

The ultra-local model involves estimating a lumped coefficient ‘F,’ assumed to encapsulate all the system dynamics. Once the value of ‘F’ is determined through estimation, it becomes a feed-forward term in the control law. This integration allows for the establishment of a known dynamic model. The ultra-local model enables control over a system with initially unknown dynamics by shaping it to exhibit known dynamics. The success of the model lies in accurate estimation of ‘F.’ Estimation of the system dynamics is required because the reference governor requires some form of model input. By introducing dynamic model through the ultra-local model, the ability to leverage the reference governor is enabled. The reference governor, projecting the reference lateral acceleration from the path planner into the future, assesses potential constraint violations. If it anticipates issues with the provided reference, it suggests an alternative reference. This alternative reference is then fed back to the ultra-local model for control. The ultra-local model operates in two phases-first estimating the dynamics encapsulated by ‘F’ and then incorporating a set of known dynamics. In essence, it nullifies the dynamics represented by ‘F’ and replaces them with a dynamic model that the reference governor is knowledgeable about. The ultra-local model serves a dual purpose. It operates as an estimator to determine the value of ‘F’ and integrates it into the control law to implement dynamics recognized by the reference governor, preventing constraint violations.

FIG. 11 shows a Chance Constrained Reference Governor based on an Ultra-Local Model (CCRG-ULM) according to an embodiment. The system comprises a Chance Constrained Reference Governor 1102, a Controller 1104, and the system 1106. According to an embodiment, the system 1106 is a data-driven model representing dynamics of a tractor-trailer vehicle.

A controller 1104 in control systems influences the behavior of a dynamic system to achieve desired objectives. Its key characteristics include the incorporation of a feedback mechanism, where the system's output is continuously compared to a reference value, enabling the controller to make real-time adjustments. Employing decision-making logic or algorithms, the controller processes the feedback information to determine appropriate modifications to the system's inputs. This involves generating control signals that influence the system's behavior, ultimately steering it towards the desired state. Often operating in a closed-loop control system, controllers exhibit adaptability to changes in conditions or disturbances.

Data-Driven Model Approach: Data-driven model of a lateral vehicle controller is robust to changes in load or operating conditions. It further requires sensors on the tractor enabling flexibility in using any kind of trailers to be used with the tractor.

Ultra-Local model: For estimating the system using an ultra-local model, assume the system has the model (29)

$${\dot{a}}_{y} = F + α u \qquad ( 29 )$$

Estimate F and use the control law

$$u = \frac{- F - {k}_{p} e + {{\dot{a}}_{y}}^{*}}{α} \qquad ( 30 )$$

This creates the differential equation ė+kₚe=0 that stabilizes the system

α|kₚ are constants selected by the engineer. e=a_{y}*−a_{y}

a_{y}* is the reference lateral acceleration

u is a commanded steer angle

F is estimated using the equation, which only requires measurements of a_{y}.

$$\hat{F} = \frac{( {a}_{y , k} - {a}_{y , k - 1} + α u Δ t )}{Δ t} \qquad ( 31 )$$

Chance Constrained Ultra-Local Model: It is possible to control the lateral acceleration of the tractor directly using the controller. For limiting the lateral acceleration and preventing rollovers the dynamics of the system can be formulated as (32)

$${\dot{a}}_{y} = - {k}_{p} {a}_{y} + {k}_{p} {a}_{y}^{*} + {{\dot{a}}_{y}}^{*} \qquad ( 32 )$$

From this equation, it is evident that the future states only depend on the current state and reference i.e., a_{y}* is the reference lateral acceleration. The reference governor is a tool that will modify the reference signal a_{y}* minimally to ensure future states satisfy the constraints as (33):

$${a}_{y} \leq {a}_{y , max} or {a}_{y , min} \leq {a}_{y} \qquad ( 33 )$$

Normal Reference governors cannot account for unbounded stochastic disturbances (i.e. measurement noise or wind disturbances). Chance constraints instead formulate the state constraints to be as shown in (34)

$$P ( {a}_{y} \leq A ) \geq β \qquad ( 34 )$$

where A is a set of acceptable constraint level, where A can be positive or negative. For a scenario where the constraint level is on maximum lateral acceleration, it can be expressed as (35):

$$P ( {a}_{y} \leq {a}_{y , max} ) \geq β \qquad ( 35 )$$

From the equation (35), the probability of satisfying the constraint must be greater than a value β which can be selected by the engineer. This constraint formulation allows for the reference governor to be able to handle stochastic disturbances which could be encountered in the real world.

Use of the Chance Constrained Reference Governor can handle practical issues such as sensor noise and other stochastic disturbances.

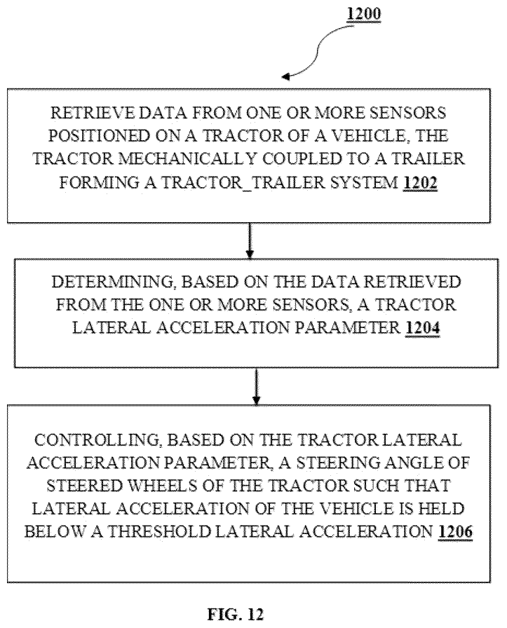

FIG. 12 shows a flow chart for implementing the method for rollover prevention in truck-trailer combination according to an embodiment. According to an embodiment, it is a method 1200 for a vehicle, comprising retrieving data from one or more sensors positioned on a tractor of the vehicle, the tractor mechanically coupled to a trailer forming a tractor-trailer system at step 1202; determining, based on the data retrieved from the one or more sensors, lateral acceleration parameter of the tractor at step 1204; and controlling based on the lateral acceleration parameter of the tractor, a steering angle of steered wheels of the tractor such that lateral acceleration of the vehicle is held below a threshold lateral acceleration at step 1206. One or more sensors comprise at least Inertial measurement unit (IMU), inductive sensors for measuring road wheel speed, and Global Positioning System (GPS). A lateral acceleration parameter can be determined based on a Kalman filter which will optimally estimate the lateral acceleration of the truck by combining all relevant measurements such as accelerometer readings, gyroscope readings, wheel speed sensors, GPS data, steering angle sensors, and yaw rate sensors. Besides the Kalman filter, alternative methods for estimating lateral acceleration from measured sensor data may include extended Kalman filters, particle filters (a Monte Carlo-based Bayesian filtering technique), sensor fusion algorithms combining data from accelerometers, gyroscopes, wheel speed sensors, GPS, steering angle sensors, and yaw rate sensors, machine learning models trained on historical data, and dynamic model estimation using vehicle dynamics or state-space models.

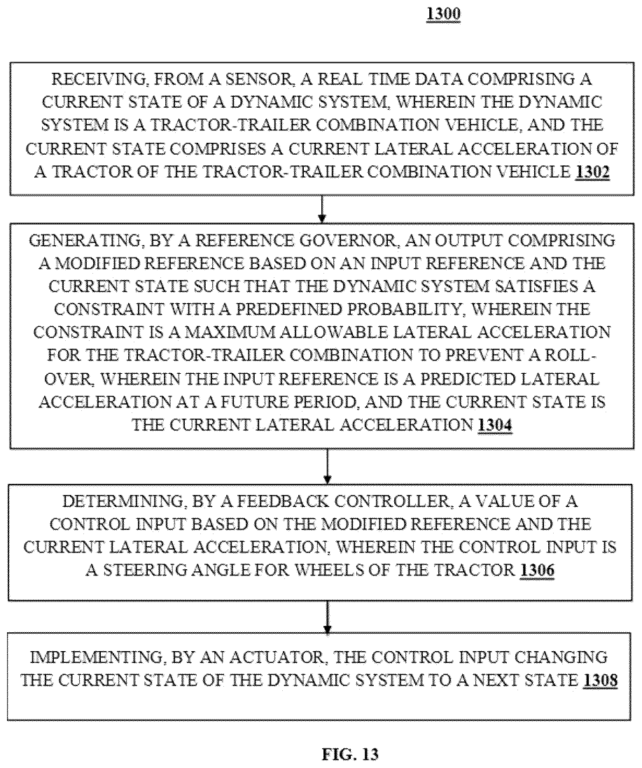

FIG. 13 shows a flow chart for implementing the method for rollover prevention in truck-trailer combination according to an embodiment. According to an embodiment, it is a method 1300 comprising receiving, from a sensor, a real-time data comprising a current state of a dynamic system, wherein the dynamic system is a tractor-trailer combination vehicle, and the current state comprises a current lateral acceleration of a tractor of the tractor-trailer combination vehicle at step 1302; generating, by a reference governor, an output comprising a modified reference based on an input reference and the current state such that the dynamic system satisfies a constraint with a predefined probability, wherein the constraint is a maximum allowable lateral acceleration for the tractor-trailer combination to prevent a rollover, wherein the input reference is a predicted lateral acceleration at a future time period, and the current state is the current lateral acceleration at step 1304; determining, by a feedback controller, a value of a control input based on the modified reference and the current lateral acceleration, wherein the control input is a steering angle for wheels of the tractor at step 1306; implementing, by an actuator, the control input changing the current state of the dynamic system to a next state at step 1308; wherein the method is implemented by a control system that is configured for preventing the rollover of the dynamic system.

In one embodiment, the application of reference governors with an ultra-local model extends beyond the current context and finds utility in diverse domains such as aircraft control, sailboat control, and various autonomous systems. These reference governors can be designed and fine-tuned with specific control laws tailored to selected inputs and outputs, highlighting their versatility. For instance, in aircraft control, the reference governor with an ultra-local model could be employed for roll stability control. The system would assess and adjust the control inputs, such as aileron deflections, based on the estimated dynamics and known constraints to ensure optimal roll stability control during flight, ensuring precise adherence to specified constraints. Similarly, in sailboat control, a reference governor with an ultra-local model could analyze and modify sail and rudder inputs sent to the actuator for control, based on the estimated dynamics using data-driven models to prevent excessive rolling, for a stable and comfortable ride. Similarly, in Unmanned Aerial Vehicle (UAV) roll stability, a reference governor with an ultra-local model may ensure controlled flight by dynamically adjusting aileron deflections based on real-time estimations of the UAV's dynamics via data-driven model/s. The Chance Constrained ULM approach ensures a prescribed level of confidence that a particular action for e.g., rollover will be avoided, allowing the UAV to navigate through varying wind conditions and disturbances while maintaining optimal roll stability behavior. The adaptability of this approach extends to a wide range of autonomous systems, offering tailored solutions for specific control challenges.

According to an embodiment, a reference governor may be an adaptive reference governor. In an embodiment, to enforce constraint satisfaction, an adaptive reference governor (ARG) adjusts the desired reference to a constraint admissible reference using the data obtained during the operation of the vehicle or the dynamic system. The data can include states, outputs, and/or references obtained at the current time or stored from previous times.

In an embodiment, the data-driven adaptive reference governor, or the chance constrained reference governor may be interfaced with a system that is controlled by a legacy control system.

In an embodiment, a method for controlling a system is disclosed. The method may include acquiring system states, reference inputs, and system parameters from a set of measured system states, a set of admissible reference inputs, and a set of admissible system parameters, wherein the set of measured system states, the set of admissible reference inputs, and the set of admissible system parameters have been collected during past operations and current operations of the system; providing a system state estimate, a reference input, a system parameter estimate and a desired reference to an adaptive reference governor (ARG); transmitting a reference input generated by the ARG to a system; extracting and providing a pair of the reference input and the system state estimate to a parameter estimator; computing a boundary interval of parameters using the parameter estimator; updating the reference input using the ARG; and computing a parameter-robust constraint admissible set using the ARG based on the updated reference input and system states. The parameter estimator uses measurements made during the operation of the system and generates estimates of the system states and estimates of the uncertain parameters of the system. In an embodiment, the system further comprises an artificial intelligence/machine learning program that dynamically learns constraint admissible sets by combining off-line data, based on sampling, and online data provided by the parameter estimator. The parameter estimator usually comprises estimation algorithms deployed on a processor that uses stored data in memory, including stored previous state estimates, parameter estimates, covariance matrices, and so on. Examples of parameter estimators can include linear and nonlinear observers, Kalman filters with state augmentation, and recursive least squares filters when full state feedback is available. Estimated parameters could include one or more of a mass of a vehicle, an inertia of a vehicle, a tire friction coefficient of at least one tire mounted on a vehicle, viscous damping coefficients in servomotors, and amplification factor of the lateral acceleration between the tractor and the trailer.

According to an embodiment, disclosed herein is a method for a vehicle, comprising retrieving data from one or more sensors positioned on a tractor of the vehicle, wherein the tractor is mechanically coupled using a mechanical coupling to a trailer forming a tractor-trailer system; determining, based on the data retrieved from the one or more sensors, a lateral acceleration parameter of the tractor; and controlling based on the lateral acceleration parameter of the tractor, a steering angle of steered wheels of the tractor such that lateral acceleration of the vehicle is held below a threshold lateral acceleration, and wherein one or more sensors comprise at least Inertial measurement unit (IMU), inductive sensors for measuring road wheel speed, and Global Positioning System (GPS).

According to an embodiment of the method, which optionally includes any one or more of previous embodiments, the threshold lateral acceleration is selected such that rollover of one or more of the tractor and the trailer is avoided.

According to an embodiment of the method, which optionally includes any one or more of previous embodiments, the one or more sensors comprises an accelerometer.

According to an embodiment of the method, which optionally includes any one or more of previous embodiments, the accelerometer is part of an inertial measurement unit of the vehicle.

According to an embodiment of the method, which optionally includes any one or more of previous embodiments, the mechanical coupling is configured to be a flexible connection.

According to an embodiment of the method, which optionally includes any one or more of previous embodiments, the lateral acceleration parameter of the vehicle is held below the threshold lateral acceleration by a reference governor.

According to an embodiment of the method, which optionally includes any one or more of previous embodiments, the reference governor receives a reference of the lateral acceleration parameter for a maneuver path from an Advanced Driver Assistance System (ADAS).

According to an embodiment of the method, which optionally includes any one or more of previous embodiments, the maneuver path is an obstacle avoidance path generated after sensing an obstacle in the path which the vehicle is following.

According to an embodiment of the method, which optionally includes any one or more of previous embodiments, the reference governor is configured as a chance constrained reference governor such that the lateral acceleration parameter of the vehicle is held below the threshold lateral acceleration with a predefined probability.

According to an embodiment of the method, which optionally includes any one or more of previous embodiments, the steering angle is controlled via an actuator configured to control an angle of steered wheels.

According to an embodiment of the method, which optionally includes any one or more of previous embodiments, the method is configured to change a current state of the tractor-trailer system to a next state.

According to an embodiment of the method, which optionally includes any one or more of previous embodiments, the tractor-trailer system is controlled using a data-driven model.

According to an embodiment of the method, which optionally includes any one or more of previous embodiments, the data-driven model comprises an ultra-local model.

According to an embodiment of the method, which optionally includes any one or more of previous embodiments, the ultra-local model is formulated such that a future state depends on a current state and a reference, wherein the current state is the lateral acceleration parameter of the tractor in a current time period and the reference is a lateral acceleration predicted along a maneuver at an immediate future time period.

According to an embodiment of the method, which optionally includes any one or more of previous embodiments, the reference is modified by reference governor for enforcement of a constraint on an allowable maximum lateral acceleration of the tractor-trailer system.

According to an embodiment of the method, which optionally includes any one or more of previous embodiments, the maneuver is generated from an ADAS of the vehicle.

According to an embodiment of the method, which optionally includes any one or more of previous embodiments, the allowable maximum lateral acceleration of the tractor-trailer system is generated based on an amplification factor of the lateral acceleration from the tractor to the trailer.

According to an embodiment, disclosed is a control system comprising a sensor, a reference governor, and a feedback controller; the sensor configured to provide real-time data comprising a current state of a dynamic system, wherein the dynamic system is a tractor-trailer combination vehicle, and the current state comprises a current lateral acceleration of a tractor of the tractor-trailer combination vehicle; the reference governor, configured to output a modified reference based on an input reference and the current state such that the dynamic system satisfies a constraint; the feedback controller configured to determine a value of a control input based on the modified reference and the current state; and wherein the control system is configured for a data-driven model-based control comprising an ultra-local model of the dynamic system; and wherein the control system is configured for preventing a rollover of the tractor-trailer combination vehicle. In an embodiment, for the tractor-trailer system, the current state comprises lateral acceleration but in a more general sense it could be any arbitrary state for example, a roll angle for a plane.

According to an embodiment of the control system, which optionally includes any one or more of previous embodiments, the sensor comprises an accelerometer.

According to an embodiment of the control system, which optionally includes any one or more of previous embodiments, the accelerometer is part of an inertial measurement unit of a vehicle.

According to an embodiment of the control system, which optionally includes any one or more of previous embodiments, the tractor and trailer are connected via a mechanical coupling.

According to an embodiment of the control system, which optionally includes any one or more of previous embodiments, the modified reference satisfies the constraint on allowable maximum lateral acceleration of the tractor-trailer combination vehicle.

According to an embodiment of the control system, which optionally includes any one or more of previous embodiments, the reference governor receives the input reference for a maneuver path from an Advanced Driver Assistance System (ADAS).

According to an embodiment of the control system, which optionally includes any one or more of previous embodiments, the maneuver path is an obstacle avoidance path generated after sensing an obstacle along a current trajectory of the tractor-trailer combination vehicle.

According to an embodiment of the control system, which optionally includes any one or more of previous embodiments, the maneuver path is generated from an ADAS of the vehicle.

According to an embodiment of the control system, which optionally includes any one or more of previous embodiments, the reference governor is configured as a chance constrained reference governor such that the modified reference satisfies the constraint with a predefined probability.

According to an embodiment of the control system, which optionally includes any one or more of previous embodiments, the constraint is a maximum allowable lateral acceleration for the tractor-trailer combination vehicle to prevent the rollover of one or more of the tractor and the trailer.

According to an embodiment of the control system, which optionally includes any one or more of previous embodiments, the input reference is a predicted lateral acceleration at a future time period.

According to an embodiment of the control system, which optionally includes any one or more of previous embodiments, the current state is the current lateral acceleration.

According to an embodiment of the control system, which optionally includes any one or more of previous embodiments, the control input is a steering angle for wheels of the tractor.

According to an embodiment of the control system, which optionally includes any one or more of previous embodiments, an actuator is configured to receive and implement the control input changing the current state of the dynamic system to a next state.

According to an embodiment of the control system, which optionally includes any one or more of previous embodiments, the reference governor is configured to handle a disturbance that is unbounded and stochastic.

According to an embodiment of the control system, which optionally includes any one or more of previous embodiments, the disturbance is represented as a Gaussian distribution.

According to an embodiment of the control system, which optionally includes any one or more of previous embodiments, the steering angle is received by an actuator.

According to an embodiment of the control system, which optionally includes any one or more of previous embodiments, the control system is configured to change the current state of the tractor-trailer combination vehicle to a next state.

According to an embodiment of the control system, which optionally includes any one or more of previous embodiments, the feedback controller uses a data-driven model.

According to an embodiment of the control system, which optionally includes any one or more of previous embodiments, the data-driven model comprises the ultra-local model.

According to an embodiment of the control system, which optionally includes any one or more of previous embodiments, the ultra-local model is formulated such that a future state depends on the current state and a reference, wherein the current state is the lateral acceleration of the tractor in a current time period and the reference is a lateral acceleration predicted along a maneuver at an immediate future time period.

According to an embodiment, disclosed is a method comprising receiving, from a sensor, a real-time data comprising a current state of a dynamic system, wherein the dynamic system is a tractor-trailer combination vehicle, and the current state comprises a current lateral acceleration of a tractor of the tractor-trailer combination vehicle; generating, by a reference governor, an output comprising a modified reference based on an input reference and the current state such that the dynamic system satisfies a constraint; determining, by a feedback controller, a value of a control input based on the modified reference and the current state; and wherein the method is implemented by a control system that is configured for preventing a rollover of the dynamic system.

According to an embodiment of the method, which optionally includes any one or more of previous embodiments, the constraint is a maximum allowable lateral acceleration for the tractor-trailer combination vehicle to prevent the rollover.

According to an embodiment of the method, which optionally includes any one or more of previous embodiments, the maximum allowable lateral acceleration of the tractor-trailer combination vehicle is generated using an amplification factor of a lateral acceleration from the tractor to the trailer.

According to an embodiment of the method, which optionally includes any one or more of previous embodiments, the constraint is enforced with a predefined probability.

According to an embodiment of the method, which optionally includes any one or more of previous embodiments, the predefined probability is in a range of 0.8 to 0.9999.

According to an embodiment of the method, which optionally includes any one or more of previous embodiments, the input reference is a predicted lateral acceleration at a future time period.

According to an embodiment of the method, which optionally includes any one or more of previous embodiments, the control input is a steering angle for wheels of the tractor.

According to an embodiment of the method, the control input is sent to an actuator.

According to an embodiment of the method, which optionally includes any one or more of previous embodiments, the control input upon implementation by the actuator changes the current state of the dynamic system to a next state.

According to an embodiment of the method, which optionally includes any one or more of previous embodiments, the control system is configured as a data-driven model-based control comprising an ultra-local model of the dynamic system.

According to an embodiment of the method, which optionally includes any one or more of previous embodiments, the ultra-local model operates in background, estimating dynamics of the dynamic system while the tractor-trailer combination vehicle is in nominal operation in real-time.

According to an embodiment of the method, which optionally includes any one or more of previous embodiments, the method is configured to be used in a maneuver with a risk of the rollover.

According to an embodiment, disclosed is a non-transitory computer-readable storage medium having stored thereon instructions executable by a computer system to perform operations comprising receiving, from a sensor, a real-time data comprising a current state of a dynamic system, wherein the dynamic system is a tractor-trailer combination vehicle, and the current state comprises a current lateral acceleration of a tractor of the tractor-trailer combination vehicle; generating, by a reference governor, an output comprising a modified reference based on an input reference and the current state such that the dynamic system satisfies a constraint with a predefined probability, wherein the constraint is a maximum allowable lateral acceleration for the tractor-trailer combination vehicle to prevent a rollover, wherein the input reference is a predicted lateral acceleration at a future time period, and the current state is the current lateral acceleration; determining, by a feedback controller, a value of a control input based on the modified reference and the current state, wherein the control input is a steering angle for wheels of the tractor; and wherein the operations are implemented by a control system that is configured for preventing a rollover of the dynamic system.

According to an embodiment of the non-transitory computer-readable storage medium, which optionally includes any one or more of previous embodiments, the control system is configured as a data-driven model-based control comprising an ultra-local model of the dynamic system.

According to an embodiment of the non-transitory computer-readable storage medium, the ultra-local model operates in background, which optionally includes any one or more of previous embodiments, estimating dynamics of the dynamic system while the tractor-trailer combination vehicle is in nominal operation in real-time.

According to an embodiment of the non-transitory computer-readable storage medium, which optionally includes any one or more of previous embodiments, the operations are configured to be used in a maneuver with a risk of the rollover.

According to an embodiment, disclosed is a method comprising: obtaining real-time input-output data from a dynamic system using one or more sensors; estimating an ultra-local model of the dynamic system using a continuously updated low-order differential equation, wherein system dynamics, including nonlinearities and disturbances, are encapsulated in an estimated parameter; computing a control signal based on the ultra-local model, using a model-free control law that dynamically adjusts based on real-time estimations; and applying the control signal to an actuator of the dynamic system to achieve a desired system response while complying with predefined constraints; and wherein the method is implemented in a control system for controlling the dynamic system using the ultra-local model based control approach; and wherein a control strategy continuously updates in response to varying system conditions, thereby enabling adaptive performance across a range of operating environments; and wherein the method is configured as the control strategy to operate the dynamic system without reliance on a predefined mathematical model of the dynamic system.

According to an embodiment, disclosed is a method for a vehicle, comprising retrieving data from one or more sensors positioned on a tractor of the vehicle, wherein the tractor is mechanically coupled to a trailer forming a tractor-trailer system; determining, based on the data retrieved from the one or more sensors, a lateral acceleration parameter of the tractor; and controlling based on the lateral acceleration parameter of the tractor, via a controller, a steering angle of steered wheels of the tractor such that a lateral acceleration of the vehicle is held below a threshold lateral acceleration.

According to an embodiment of the method, which optionally includes any one or more of previous embodiments, the one or more sensors comprises an accelerometer.

According to an embodiment of the method, which optionally includes any one or more of previous embodiments, the controller comprises a data-driven model, and wherein the data-driven model comprises an ultra-local model.

According to an embodiment of the method, which optionally includes any one or more of previous embodiments, the ultra-local model is formulated such that a future state depends on a current state and a reference, wherein the current state is the lateral acceleration parameter of the tractor in a current time period and the reference is a lateral acceleration of the tractor predicted along a maneuver at an immediate future time period.

According to an embodiment of the method, which optionally includes any one or more of previous embodiments, the reference is modified by a reference governor for enforcement of a constraint on an allowable maximum lateral acceleration of the tractor-trailer system.

According to an embodiment of the method, which optionally includes any one or more of previous embodiments, the allowable maximum lateral acceleration of the tractor-trailer system is generated based on an amplification factor of the lateral acceleration from the tractor to the trailer.

According to an embodiment of the method, which optionally includes any one or more of previous embodiments, the reference governor receives the reference of the lateral acceleration parameter for a maneuver path from an Advanced Driver Assistance System (ADAS); and wherein the maneuver path is an obstacle avoidance path generated after sensing an obstacle along a current trajectory of the tractor-trailer combination vehicle.

According to an embodiment of the method, which optionally includes any one or more of previous embodiments, the reference governor is configured as a chance constrained reference governor such that the lateral acceleration parameter of the vehicle is held below the threshold lateral acceleration with a predefined probability, and wherein the predefined probability is in a range of 0.8 to 0.9999.

According to an embodiment of the method, which optionally includes any one or more of previous embodiments, the threshold lateral acceleration is selected such that rollover of one or more of the tractor and the trailer is avoided.

According to an embodiment of the method, which optionally includes any one or more of previous embodiments, the steering angle is controlled via an actuator configured to control an angle of the steered wheels; and wherein the method is configured to change a current state of the tractor-trailer system to a next state.

According to an embodiment, disclosed is a control system comprising: a sensor, and a feedback controller; the sensor configured to provide real-time data comprising a current state of a dynamic system, wherein the dynamic system is a tractor-trailer combination vehicle, and the current state comprises a current lateral acceleration of a tractor of the tractor-trailer combination vehicle; the feedback controller configured to determine a value of a control input based on a modified reference and the current state; and wherein the control system comprises a data-driven model, wherein the data-driven model comprises an ultra-local model of the dynamic system; and wherein the control system is configured to prevent a rollover of the tractor-trailer combination vehicle.

According to an embodiment of the control system, which optionally includes any one or more of previous embodiments, the ultra-local model configured to represent the dynamic system uses a low-order differential equation, and wherein the low-order differential equation is a first order differential equation.

According to an embodiment of the control system, which optionally includes any one or more of previous embodiments, the sensor comprises an accelerometer.

According to an embodiment of the control system, which optionally includes any one or more of previous embodiments, the control system further comprises a reference governor configured to output the modified reference based on an input reference and the current state such that the dynamic system satisfies a constraint, and wherein the constraint is a maximum allowable lateral acceleration for the tractor-trailer combination vehicle to prevent the rollover of one or more of the tractor and a trailer of the tractor-trailer combination.

According to an embodiment of the control system, which optionally includes any one or more of previous embodiments, the reference governor receives the input reference for a maneuver path from an Advanced Driver Assistance System (ADAS); and wherein the maneuver path is an obstacle avoidance path generated after sensing an obstacle along a current trajectory of the tractor-trailer combination vehicle.

According to an embodiment of the control system, which optionally includes any one or more of previous embodiments, the reference governor is configured as a chance constrained reference governor such that the modified reference satisfies the constraint with a predefined probability.

According to an embodiment of the control system, which optionally includes any one or more of previous embodiments, the input reference is a predicted lateral acceleration of the tractor at a future time period.

According to an embodiment of the control system, which optionally includes any one or more of previous embodiments, the control input is a steering angle for wheels of the tractor; and wherein an actuator is configured to receive and implement the control input changing the current state of the dynamic system to a next state.

According to an embodiment, disclosed is a method comprising: receiving, from a sensor, a real-time data comprising a current state of a dynamic system, wherein the dynamic system is a tractor-trailer combination vehicle, and the current state comprises a current lateral acceleration of a tractor of the tractor-trailer combination vehicle; determining, by a feedback controller of a control system, a value of a control input based on a modified reference and the current state, wherein the control system comprises a data-driven model, wherein the data-driven model comprises an ultra-local model of the dynamic system; and providing, the control input to an actuator of the dynamic system, such that the dynamic system changes from the current state to a next state; and wherein the method is implemented by the control system for preventing a rollover of the tractor-trailer combination vehicle.

According to an embodiment of the method, which optionally includes any one or more of previous embodiments, the ultra-local model of the control system is formulated by estimating dynamics of the dynamic system in real-time while the tractor-trailer combination vehicle is in nominal operation.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

### INCORPORATION BY REFERENCE

All references, including granted patents and patent application publications, referred herein are incorporated herein by reference in their entirety.
Paper Publication: A. Dongare, R. Hamrah, I. Kolmanovsky and A. K. Sanyal, “Reference Governor for Constrained Data-Driven Control of Aerospace Systems with Unknown Input-Output Dynamics,” 2023 IEEE Conference on Control Technology and Applications (CCTA), Bridgetown, Barbados, 2023, pp. 853-858, doi: 10.1109/CCTA54093.2023.10252101.

1-55. (canceled)

56. A method for a vehicle, comprising:
retrieving data from one or more sensors positioned on a tractor of the vehicle, wherein the tractor is mechanically coupled to a trailer forming a tractor-trailer system;
determining, based on the data retrieved from the one or more sensors, a lateral acceleration parameter of the tractor; and
controlling based on the lateral acceleration parameter of the tractor, via a controller, a steering angle of steered wheels of the tractor such that a lateral acceleration of the vehicle is held below a threshold lateral acceleration.

57. The method of claim 56, wherein the one or more sensors comprises an accelerometer.

58. The method of claim 56, wherein the controller comprises a data-driven model, and wherein the data-driven model comprises an ultra-local model.

59. The method of claim 58, wherein the ultra-local model is formulated such that a future state depends on a current state and a reference, wherein the current state is the lateral acceleration parameter of the tractor in a current time period and the reference is a lateral acceleration of the tractor predicted along a maneuver at an immediate future time period.

60. The method of claim 59, wherein the reference is modified by a reference governor for enforcement of a constraint on an allowable maximum lateral acceleration of the tractor-trailer system.

61. The method of claim 60, wherein the allowable maximum lateral acceleration of the tractor-trailer system is generated based on an amplification factor of the lateral acceleration from the tractor to the trailer.

62. The method of claim 60, wherein the reference governor receives the reference of the lateral acceleration parameter for a maneuver path from an Advanced Driver Assistance System (ADAS); and wherein the maneuver path is an obstacle avoidance path generated after sensing an obstacle along a current trajectory of the vehicle.

63. The method of claim 60, wherein the reference governor is configured as a chance constrained reference governor such that the lateral acceleration parameter of the vehicle is held below the threshold lateral acceleration with a predefined probability, and wherein the predefined probability is in a range of 0.8 to 0.9999.

64. The method of claim 56, wherein the threshold lateral acceleration is selected such that rollover of one or more of the tractor and the trailer is avoided.

65. The method of claim 56, wherein the steering angle is controlled via an actuator configured to control an angle of the steered wheels; and wherein the method is configured to change a current state of the tractor-trailer system to a next state.

66. A control system comprising:
a sensor, and a feedback controller;
the sensor configured to provide real-time data comprising a current state of a dynamic system, wherein the dynamic system is a tractor-trailer combination vehicle, and the current state comprises a current lateral acceleration of a tractor of the tractor-trailer combination vehicle;
the feedback controller configured to determine a value of a control input based on a modified reference and the current state; and
wherein the control system comprises a data-driven model, wherein the data-driven model comprises an ultra-local model of the dynamic system; and
wherein the control system is configured to prevent a rollover of the tractor-trailer combination vehicle.

67. The control system of claim 66, wherein the ultra-local model configured to represent the dynamic system uses a low-order differential equation, and wherein the low-order differential equation is a first-order differential equation.

68. The control system of claim 66, wherein the sensor comprises an accelerometer.

69. The control system of claim 66, wherein the control system further comprises a reference governor configured to output the modified reference based on an input reference and the current state such that the dynamic system satisfies a constraint, and wherein the constraint is a maximum allowable lateral acceleration for the tractor-trailer combination vehicle to prevent the rollover of one or more of the tractor and a trailer of the tractor-trailer combination vehicle.

70. The control system of claim 69, wherein the reference governor receives the input reference for a maneuver path from an Advanced Driver Assistance System (ADAS); and wherein the maneuver path is an obstacle avoidance path generated after sensing an obstacle along a current trajectory of the vehicle.

71. The control system of claim 69, wherein the reference governor is configured as a chance constrained reference governor such that the modified reference satisfies the constraint with a predefined probability.

72. The control system of claim 69, wherein the input reference is a predicted lateral acceleration of the tractor at a future time period.

73. The control system of claim 66, wherein the control input is a steering angle for wheels of the tractor; and wherein an actuator is configured to receive and implement the control input changing the current state of the dynamic system to a next state.

74. A method comprising:
receiving, from a sensor, a real-time data comprising a current state of a dynamic system, wherein the dynamic system is a tractor-trailer combination vehicle, and the current state comprises a current lateral acceleration of a tractor of the tractor-trailer combination vehicle;
determining, by a feedback controller of a control system, a value of a control input based on a modified reference and the current state, wherein the control system comprises a data-driven model, wherein the data-driven model comprises an ultra-local model of the dynamic system; and
providing, the control input to an actuator of the dynamic system, such that the dynamic system changes from the current state to a next state; and
wherein the method is implemented by the control system for preventing a rollover of the tractor-trailer combination vehicle.

75. The method of claim 74, wherein the ultra-local model of the control system is formulated by estimating dynamics of the dynamic system in real-time while the tractor-trailer combination vehicle is in nominal operation.
